(19) United States
(12) Patent Application Publication
(10) Pub. No.: US 2026/0057600 A1
(43) Pub. Date: Feb. 26, 2026

(54) OPTIMIZING RAY TRACING IN IMAGE RENDERING USING CLUSTER-BASED ACCELERATION

(71) Applicant: NVIDIA Corporation, Santa Clara, CA (US)

(72) Inventors: Frank JARGSTORFF, Oakland, CA (US); Ardavan KANANI, Germantown, MD (US); Manuel KRAEMER, San Jose, CA (US); Dylan LACEWELL, Fremont, CA (US); Steven G. PARKER, Draper, UT (US); Feng WANG, Millcreek, UT (US); David Augustus HART, Salt Lake City, UT (US)

(73) Assignee: NVIDIA Corporation, Santa Clara, CA (US)

(21) Appl. No.: 18/814,076

(22) Filed: Aug. 23, 2024

(51) Int. Cl. G06T 15/06; G06V 10/764

(52) U.S. Cl. CPC G06T 15/06; G06V 10/764

(57) ABSTRACT

In various examples, systems and methods are disclosed that relate to the generation of images of cluster-based structures. For example, a system can obtain scene data associated with a scene of a three-dimensional environment, the scene comprising a plurality of objects; determine a first set of surfaces and a second set of surfaces, each surface of the first set of surfaces and the second set of surfaces corresponding to at least one object of the plurality of objects; and update the surfaces of the first set of surfaces based at least on a classification associated with the first set of surfaces. In examples, the system can generate an image based at least on updating the first set of surfaces. Updating the first set of surfaces can include tessellating the primitives of each surface of the first set of surfaces in accordance with a tessellation factor.

### BACKGROUND

Ray tracing has gained prominence as a powerful technique for simulating the way light interacts with objects in a virtual scene for generating realistic images. For example, to generate a scene with multiple objects, multiple rays can be traced from an origin (e.g., from the point of view of a camera) across an image plane and subsequently to the surfaces of objects in a field of view associated with the origin. Once a ray is traced to a point along the surface of an object, the ray “hits” the object and one or more rays are then projected from that point toward either a light source, other objects in the scene, or back toward the origin. These rays that are projected from the point are sometimes referred to being traced in a “reflection direction” or a “refraction direction” and rays that are traced toward a light source are sometimes referred to as “shadow rays.” This process (more specifically referred to as ray casting) can continue recursively until a desired number of rays are traced to one or more light sources to enable the rendering of an image.

Until recently, it was computationally infeasible to perform real-time ray tracing. However, advances in graphic hardware development along with improved algorithms implemented in software have made real-time ray tracing feasible. This, in turn, has led to growing adoption of ray tracing techniques to render increasingly complex images. But as demand for higher-complexity images grows, it's becoming difficult to render these images in reasonable amounts of time, much less real-time. For example, it can take minutes, hours, or even days to render a photorealistic image of a hilly, wooden environment where rays are traced to and/or between objects such as rocks, trees, leaves, streams, and/or the like. Along with the significant time, rendering these images is also an extremely computationally expensive process. While certain techniques exist when it comes to streamlining the rasterization process, conventional techniques associated with ray tracing involve the analysis and/or rendering of any part of a scene so long as the part in the scene is ultimately visible (e.g., even in reflections across any number of surfaces in the scene). Because there are no conventional techniques that address the scaling complexity of a scene to be rendered using ray tracing, some scenes simply cannot be rendered in real time.

### SUMMARY

Embodiments of the present disclosure relate to systems and methods for generating images of cluster-based structures. More specifically, in some embodiments, systems and methods are disclosed that involve generating images of cluster-based structures within a three-dimensional environment.

Techniques described by the present disclosure improve the way in which ray tracing (and light transport simulation generally) of microgeometries is performed. For example, a system that is performing ray tracing for a scene can determine a first set of surfaces and a second set of surfaces (corresponding to microgeometries in the scene) for objects that are located in a scene and update the surfaces based at least on a classification associated with each surface. As used, the term “microgeometries” refers to graphical primitives used to construct surfaces of objects within a virtual scene (“scene”). Examples of microgeometries include triangles, quads, ellipsoids or gaussians, and/or the like, that, when rendered, represent an area in a rendered image. This updating can involve tessellating the primitives associated with surfaces using varying tessellation factors according to the surface classifications. In one example, a tessellation factor can be set to a higher value for surfaces that are closer to the origin (e.g., a point from which rays are cast from the camera) whereas a tessellation factor with a lower value can be used for surfaces that are farther from the origin. Additionally, or alternatively, tessellation factors can be set based at least on: whether the surfaces are visible or not visible from the origin, whether the surfaces are within a field of view associated with the origin (e.g., within a view frustum projected from the origin into the scene), and/or whether distances to the surfaces, compared to corresponding distances stored in a Z-buffer, are lower than the distances stored in the Z-buffer, indicating that the surface is a visible surface.

By varying and updating the tessellation factor used to tessellate a given surface based at least on these criteria, surfaces that are more critical to the photorealism of an image (e.g., closer surfaces, visible surfaces, directly visible surfaces, and/or the like) can be tessellated at higher rates, resulting in higher resolution of such surfaces and the application of more realistic effects (e.g., improved shadow gradients and/or the like) when compared to other surfaces that are less critical. This, in turn, reduces the computational requirements to render a given image and allows for the allocation of available computational resources to rendering targeted portions of the scene that have a greater impact on the overall photorealism of the scene.

By performing these updates, portions of the surfaces within a scene can be updated through the selective application of tessellation factors to iteratively update the level of detail (LOD) of portions of surfaces and/or create more photorealistic images while optimizing computing resources available to generate such images. The presently-disclosed systems and methods can also selectively apply tessellation factors to manage the increasing complexity of scenes and/or maintain sources of data that can be used to derive scalable representations of such scenes.

At least one aspect relates to one or more processors. The one or more processors can include one or more circuits to obtain scene data associated with a scene of a three-dimensional environment, the scene comprising a plurality of objects, at least one (e.g., each) object associated with a plurality of primitives; determine a first set of surfaces and a second set of surfaces corresponding to the plurality of objects, at least one (e.g., each) surface of the first set of surfaces and the second set of surfaces associated with one or more primitives of the plurality of primitives; update the one or more primitives associated with the first set of surfaces based at least on a classification of the first set of surfaces; and generate a rendered image based at least on updating the one or more primitives associated with the first set of surfaces. In some implementations, the one or more circuits that update the one or more primitives associated with the first set of surfaces, are further to update the one or more primitives associated with the first set of surfaces by tessellating the one or more primitives associated with the first set of surfaces based at least on a first tessellation factor that is associated with the classification of the first set of surfaces. In some implementations, the one or more circuits are to update the one or more primitives associated with the second set of surfaces by tessellating the one or more primitives associated with the second set of surfaces based at least on a second tessellation factor that is associated with the classification of the second set of surfaces, where the first tessellation factor is greater than the second tessellation factor.

In some implementations, the classification associated with the first set of surfaces indicates the surfaces of the first set of surfaces are forward-facing surfaces, and where the classification associated with the second set of surfaces indicates the surfaces of the second set of surfaces are not forward-facing surfaces, the first tessellation factor is greater than the second tessellation factor.

In some implementations, the classification associated with the first set of surfaces can indicate the surfaces of the first set of surfaces satisfy a first distance threshold, and the classification associated with the second set of surfaces can indicate the surfaces of the second set of surfaces satisfy a second distance threshold. The first tessellation factor can be greater than the second tessellation factor. The first distance threshold and the second distance threshold can be associated with distances from an origin to respective surfaces of the first set of surfaces and the second set of surfaces.

In some implementations, the classification associated with the first set of surfaces can indicate the surfaces of the first set of surfaces are located in a first area of the scene that is directly visible from a view frustum, and the classification associated with the second set of surfaces can indicate the surfaces of the second set of surfaces are located in a second area of the scene that is not directly visible from a view frustum, the first tessellation factor is greater than the second tessellation factor.

In some implementations, the classification associated with the first set of surfaces can indicate the surfaces of the first set of surfaces are closer than corresponding depths stored in a hierarchical Z-buffer, and the classification associated with the second set of surfaces can indicate the surfaces of the second set of surfaces are farther than corresponding depths stored in the hierarchical Z-buffer, the first tessellation factor is greater than the second tessellation factor.

In some implementations, the one or more circuits that determine the first set of surfaces and the second set of surfaces corresponding to the respective objects of the plurality of objects are to determine the one or more primitives corresponding to at least one (e.g., each) surface of the first set of surfaces and the second set of surfaces. In some implementations, the one or more circuits that update the one or more primitives associated with the first set of surfaces based at least on the classification associated with the first set of surfaces are further to tessellate the one or more primitives corresponding to at least one (e.g., each) surface of the first set of surfaces based at least on a tessellation factor.

In some implementations, the one or more circuits that determine the first set of surfaces and the second set of surfaces are to determine a classification associated with surfaces associated with the plurality of objects; and determine the one or more primitives associated with the first set of surfaces and the second set of surfaces based at least on the surfaces associated with the plurality of objects and/or the classification associated with each surface associated with the plurality of objects.

In some implementations, the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system for generating synthetic data; a system incorporating one or more large language models (LLMs) or one or more vision language models (VLMs); a system incorporating one or more virtual machines (VMs); a system implemented at least partially in a data center; or a system implemented at least partially using cloud computing resources.

At least one aspect relates to a system. The system can include one or more processors to perform operations. In some implementations, the operations include receiving scene data associated with a scene of a three-dimensional environment, the scene comprising a plurality of objects, with one or more (e.g., each) object being associated with a plurality of primitives; determining a first set of surfaces and a second set of surfaces corresponding to the plurality of objects, one or more (e.g., each) surface of the first set of surfaces and the second set of surfaces associated with one or more primitives of the plurality of primitives; updating the one or more primitives associated with the first set of surfaces based at least on a classification of the first set of surfaces; and generating an image based at least on updating the one or more primitives associated with the first set of surfaces.

In some implementations, the one or more processors that perform the operation of updating the one or more primitives associated with the first set of surfaces are to perform the operation of: updating the one or more primitives associated with the first set of surfaces by tessellating the one or more primitives associated with the first set of surfaces based at least on a first tessellation factor that is associated with the classification of the first set of surfaces. In some implementations, the one or more processors are to perform the operation of updating the one or more primitives associated with the second set of surfaces by tessellating the one or more primitives associated with the second set of surfaces based at least on a second tessellation factor that is associated with the classification of the second set of surfaces, wherein the first tessellation factor is greater than the second tessellation factor.

In some implementations, the classification associated with the first set of surfaces can indicate the surfaces of the first set of surfaces are forward-facing surfaces, and the classification associated with the second set of surfaces can indicate the surfaces of the second set of surfaces are not forward-facing surfaces. The first tessellation factor can be greater than the second tessellation factor.

In some implementations, the classification associated with the first set of surfaces can indicate the surfaces of the first set of surfaces satisfies a first distance threshold, and the classification associated with the second set of surfaces can indicate the surfaces of the second set of surfaces satisfy a second distance threshold. The first tessellation factor can be greater than the second tessellation factor. The first distance threshold and the second distance threshold can be associated with distances from an origin to respective surfaces of the first set of surfaces and the second set of surfaces.

In some implementations, the classification associated with the first set of surfaces can indicate the surfaces of the first set of surfaces are located in a first area of the scene that is directly visible from a view frustum, and the classification associated with the second set of surfaces can indicate the surfaces of the second set of surfaces are located in a second area of the scene that is not directly visible from a view frustum. The first tessellation factor can be greater than the second tessellation factor.

In some implementations, the classification associated with the first set of surfaces can indicate the surfaces of the first set of surfaces are closer than corresponding depths stored in a hierarchical Z-buffer, and the classification associated with the second set of surfaces can indicate the surfaces of the second set of surfaces are farther than corresponding depths stored in the hierarchical Z-buffer. The first tessellation factor can be greater than the second tessellation factor.

In some implementations, the one or more processors that perform the operation of determining the first set of surfaces and the second set of surfaces corresponding to the respective objects of the plurality of objects are to perform the operation of: determining the one or more primitives corresponding to each surface of the first set of surfaces and the second set of surfaces, and wherein, the one or more processors that perform the operation of updating the one or more primitives associated with the first set of surfaces based at least on the classification associated with the first set of surfaces are to perform the operation of tessellating the one or more primitives corresponding to one or more (e.g., each) surface of the first set of surfaces based at least on a tessellation factor.

In some implementations, the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system for generating synthetic data; a system incorporating one or more large language models (LLMs) or one or more vision language models (VLMs); a system incorporating one or more virtual machines (VMs); a system implemented at least partially in a data center; or a system implemented at least partially using cloud computing resources.

At least one aspect relates to a method. In some implementations, the method includes receiving scene data associated with a scene of a three-dimensional environment, the scene comprising a plurality of objects, each object of the plurality of objects associated with a plurality of primitives; determining a first set of surfaces and a second set of surfaces corresponding to the plurality of objects, each surface of the first set of surfaces and the second set of surfaces associated with one or more primitives of the plurality of primitives; updating the one or more primitives associated with the first set of surfaces based at least on a classification of the first set of surfaces; and generating an image based at least on updating the one or more primitives associated with the first set of surfaces.

In addition to tessellating or decimating the primitives of objects in a virtual, three-dimensional (3D) environment representing a scene to improve the ray tracing process, ray tracing pipelines can be adapted to dynamically target primitives of objects for tessellation (or decimation). For example, one or more ray tracing operations can be performed (e.g., generation of an acceleration structure such as a bounding volume hierarchy (BVH) or another spatial data structure, tracing of rays through the 3D environment based at least on the acceleration structure, and/or generation of an image) and/or a depth buffer (Z-buffer) can be obtained based at least on (e.g., incidental to) the performance of the ray tracing operations. The depth buffer can be updated based at least on a change in camera position relative to at least one object. And, in some examples, the depth buffer can be reduced (e.g., in accordance with a parallel reduction operator) to form a hierarchical depth buffer (Hi-Z buffer). The hierarchical depth buffer can then be used to update (e.g., tessellate primitives of) objects and/or the ray tracing pipeline can repeat.

In examples where the one or more objects include dynamic objects (e.g., objects such as characters or other moving objects moving through an environment), a proxy object can be placed in the environment and iteratively updated in response to animation of the dynamic object. The proxy object can similarly be used to dynamically target primitives of objects for tessellation or decimation.

By virtue of updating conventional ray tracing pipelines as described above, systems can target objects for tessellation that are less likely to significantly affect the resulting images. In some examples, the techniques described involve tessellating targeted objects in accordance with a tessellation factor that causes decimation of the primitives of that object. This can have an extremely significant impact on the overall number of primitives that are used to generate acceleration structures, allowing for the application of ray tracing techniques to generate images of increasingly larger and/or complex scenes.

At least one aspect relates to one or more processors. The one or more processors can include one or more circuits to: obtain a depth buffer based at least on performance of one or more ray tracing operations; determine an update to a position of a camera relative to the plurality of objects in the environment; reproject the plurality of points based at least on the update to the position of the camera relative to the plurality of objects in the environment to generate an updated depth buffer; generate a hierarchical depth buffer (hierarchical Z-buffer) based at least on reprojecting the plurality of points; and update at least one object of the plurality of objects of the environment based at least on the hierarchical depth buffer and/or one or more tessellation rates. The depth buffer can include distances to a plurality of points associated with a plurality of objects in an environment.

In some implementations, the one or more circuits to update the at least one object can: determine that the at least one object is at least visible to the camera based at least on the hierarchical depth buffer; and tessellate primitives of the at least one object of the environment based at least on determining that the at least one object is at least visible to the camera. The one or more circuits to tessellate the primitives of the at least one object can tessellate the primitives of the at least one object based at least on a tessellation factor that causes at least one primitive of the at least one object to be updated to include at least two primitives. In some implementations, the one or more circuits to update the at least one object can determine that the at least one object is at least not visible to the camera based at least on the hierarchical depth buffer. The one or more circuits can tessellate primitives of the at least one object of the environment based at least on determining that the at least one object is not at least visible to the camera. The one or more circuits to tessellate the primitives of the at least one object can update the primitives of the at least one object based at least on a tessellation factor that causes decimation of the primitives of the at least one object.

In some implementations, the plurality of objects in the environment can include a proxy object corresponding to a dynamic object. The one or more circuits to determine the update to the position of the camera relative to the plurality of objects can determine the update to the position of the camera relative to the proxy object based at least on animation of the dynamic object. In some implementations, Performance of the one or more ray tracing operations can be performed at a first point in time. The one or more circuits can cause a device to perform the one or more ray tracing operations at a second point in time based at least on updating the at least one object of the plurality of objects of the environment.

In some implementations, the one or more circuits that cause the device to perform the one or more ray tracing operations at the second point in time can cause the device to generate an acceleration structure based at least on the plurality of objects of the environment and/or the hierarchical depth buffer.

In some implementations, the one or more processors is comprised in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system for performing generative AI operations; a system for implementing vision language models (VLMs); a system for implementing large language models (LLMs); a system for hosting one or more real-time streaming applications; a system for performing light transport simulation; a system for performing collaborative content creation for 3D assets; or a system implemented at least partially using cloud computing resources.

At least one aspect relates to a system. The system can include one or more processors to perform operations. The one or more operations can include obtaining a depth buffer based at least on performance of one or more ray tracing operations, the depth buffer comprising distances to a plurality of points associated with a plurality of objects in an environment; determining an update to a position of a camera relative to the plurality of objects in the environment; and reprojecting the plurality of points based at least on the update to the position of the camera relative to the plurality of objects in the environment to generate an updated depth buffer. In some implementations, the one or more operations can include generating a hierarchical depth buffer (hierarchical Z-buffer) based at least on reprojecting the plurality of points; and updating at least one object of the plurality of objects of the environment based at least on the hierarchical depth buffer and/or one or more tessellation rates.

In some implementations, the one or more processors that perform the operations of updating the at least one object are to perform the operations of: determining that the at least one object is at least visible to the camera based at least on the hierarchical depth buffer; and tessellating primitives of the at least one object of the environment based at least on determining that the at least one object is at least visible to the camera. In some implementations, the one or more processors that tessellate the primitives of the at least one object are to perform the operation of tessellating the primitives of the at least one object based at least on a tessellation factor that causes at least one primitive of the at least one object to be updated to include at least two primitives. The one or more processors that perform the operation of updating the at least one object are to perform the operations of: determining that the at least one object is at least not visible to the camera based at least on the hierarchical depth buffer; and tessellating primitives of the at least one object of the environment based at least on determining that the at least one object is not at least visible to the camera.

In some implementations, the one or more processors that perform the operation of tessellating the primitives of the at least one object are to perform the operation of updating the primitives of the at least one object based at least on a tessellation factor that causes decimation of the primitives of the at least one object. The plurality of objects in the environment can include a proxy object corresponding to a dynamic object. In some implementations, the one or more processors that perform the operation of determining the update to the position of the camera relative to the plurality of objects are to perform the operation of: determining the update to the position of the camera relative to the proxy object based at least on animation of the dynamic object.

In some implementations, performance of the one or more ray tracing operations can occur at a first point in time. The one or more processors can perform the operation of causing a device to perform the one or more ray tracing operations at a second point in time based at least on updating the at least one object of the plurality of objects of the environment. In some implementations, the one or more processors that perform the operation of causing the device to perform the one or more ray tracing operations at the second point in time are to perform the operation of causing the device to generate an acceleration structure based at least on the plurality of objects of the environment and/or the hierarchical depth buffer.

In some implementations, the one or more processors are comprised in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system for performing generative AI operations; a system for implementing vision language models (VLMs); a system for implementing large language models (LLMs); a system for hosting one or more real-time streaming applications; a system for performing light transport simulation; a system for performing collaborative content creation for 3D assets; or a system implemented at least partially using cloud computing resources.

At least one aspect relates to a method. The method can include obtaining a depth buffer based at least on performance of one or more ray tracing operations; determining an update to a position of a camera relative to the plurality of objects in the environment; and generating a hierarchical depth buffer based at least on reprojecting the plurality of points. In some implementations, the method can include updating at least one object of the plurality of objects of the environment based at least on the hierarchical depth buffer and/or one or more tessellation rates. In some implementations, updating the at least one object can include: determining that the at least one object is at least visible to the camera based at least on the hierarchical depth buffer; and tessellating primitives of the at least one object of the environment based at least on determining that the at least one object is at least visible to the camera.

Some of the techniques described can involve a system obtaining an acceleration structure during execution of one or more operations involved in a ray tracing pipeline based at least on performance of one or more ray tracing operations for a previous frame (e.g., a frame generated for display prior to the generation of a current frame). The system can determine an update to a position of a camera for a current frame relative to the plurality of objects in the environment and generate a depth buffer representing distances between the camera and the plurality of points based at least on the update to the position of the camera. Generation of the depth buffer can include performing ray tracing operations (e.g., a first set of ray tracing operations) based at least on the points represented by the acceleration structure of the previous frame. The system can then update at least one object of the plurality of objects of the environment based at least on the distances represented by the depth buffer.

By virtue of updating conventional ray tracing pipelines to implement the features described above, systems can target objects for tessellation without the need to perform computationally expensive operations to address disoccluded pixels as objects and/or a camera involved in the ray tracing process move relative to one another (sometimes at increasing rates of speed). Specifically, the presently-disclosed techniques can significantly reduce or eliminate the chance for points to be disoccluded by virtue of the movement of the camera or the movement of dynamic objects (e.g., animated geometries) relative to the camera with each successive frame. This, in turn, can reduce the chance that primitives of objects are over-tessellated in any given frame. By tessellating objects at appropriate tessellation rates, the amount of time involved in building acceleration structures used to enable certain ray tracing techniques can be decreased, allowing for faster image generation and/or the ability for systems to generate images at higher frame rates than such systems would otherwise be capable. Further, the amount of memory involved in storing information about primitives can be significantly reduced as the overall number of primitives involved in the ray tracing process can be lowered when compared to conventional approaches.

At least one aspect relates to at least one processor. The at least one processor can include one or more circuits. The one or more circuits can obtain an acceleration structure based at least on performance of one or more ray tracing operations during generation of a previous frame. The acceleration structure can be associated with a plurality of points of a plurality of objects in an environment. The one or more circuits can determine an update to a position of a camera for a current frame relative to the plurality of objects in the environment. In examples, the one or more circuits can generate a depth buffer representing distances between the camera and the plurality of points based at least on the update to the position of the camera and update at least one object of the plurality of objects of the environment based at least on the distances.

In some implementations, the one or more circuits can generate a hierarchical depth buffer based at least on the depth buffer. The hierarchical depth buffer can include a reduced representation of the depth buffer. The one or more circuits to update the at least one object can update the at least one object based at least on the distances included in the hierarchical depth buffer by tessellating the at least one object in accordance with a tessellation rate.

In some implementations, the one or more circuits to generate the depth buffer can generate the depth buffer based at least on an acceleration structure of the previous frame. The one or more circuits to generate the depth buffer can perform one or more ray tracing operations for a current frame based at least on the plurality of points represented by the acceleration structure of the previous frame. The one or more circuits to perform the one or more ray tracing operations can trace a plurality of rays along a path from the camera to points along the plurality of objects in the environment and record depths between the camera and the points along the plurality of objects in the environment based at least on each ray of the plurality of rays contacting a first object in the path from the camera to the points along the plurality of objects.

In some aspects, the one or more circuits to perform the one or more ray tracing operations are to trace a plurality of rays from the camera to the plurality of objects in the environment, determine that a subset of rays of the plurality of rays contact objects that are static, and record depths between the camera and the plurality of objects in the updated depth buffer based at least on each ray of the subset of rays contacting the first object in the path of the respective ray and the objects being static. The subset of rays can include a first subset of rays, and the one or more circuits can forgo recording depths between the camera and the plurality of objects in the updated depth buffer based at least on each ray of a second subset of rays contacting the first object in the path of the respective ray and the object being static.

In some aspects, the one or more circuits are to determine tags the plurality of points associated with the plurality of objects in the environment. Each of the tags can indicate that a respective point is associated with a static object or a non-static object. The one or more circuits can perform the one or more ray tracing operations for a current frame based at least on the acceleration structure of the previous frame and tags of the plurality of points.

In some aspects, the at least one processor is included in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for generating or presenting at least one of augmented reality content, virtual reality content, or mixed reality content; a system for hosting one or more real-time streaming applications; a system for implementing large language models (LLMs); a system for implementing vision language models (VLMs); a system implementing one or more multi-modal language models; a system implemented using an edge device; a system implemented using a robot; a system for performing conversational AI operations; a system for performing generative AI operations; a system for generating synthetic data; a system incorporating one or more virtual machines (VMs); a system implemented at least partially in a data center; or a system implemented at least partially using cloud computing resources.

At least one aspect relates to a system. The system can include one or more processors to perform operations. The operations can include obtaining an acceleration structure based at least on performance of one or more ray tracing operations during generation of a previous frame. The acceleration structure can be associated with a plurality of points of a plurality of objects in an environment. The operations can include determining an update to a position of a camera for a current frame relative to the plurality of objects in the environment, and generating a depth buffer representing distances between the camera and the plurality of points based at least on the update to the position of the camera; and updating at least one object of the plurality of objects of the environment based at least on the distances.

In some aspects, the operations can include generating a hierarchical depth buffer based at least on the depth buffer. The hierarchical depth buffer can include a reduced representation of the depth buffer, and the one or processors to perform operations to update the at least one object can perform operations including updating the at least one object based at least on the distances included in the hierarchical depth buffer by tessellating the at least one object in accordance with a tessellation rate.

In some aspects, the one or more processors to perform operations to generate the depth buffer can perform operations including: generating the depth buffer based at least on an acceleration structure of the previous frame. The one or more processors to perform operations to generate the depth buffer can perform one or more ray tracing operations for a current frame based at least on the plurality of points represented by the acceleration structure of the previous frame. The one or more processors to perform one or more ray tracing operations can trace a plurality of rays along a path from the camera to points along the plurality of objects in the environment, and record depths between the camera and the points along the plurality of objects in the environment based at least on each ray of the plurality of rays contacting a first object in the path from the camera to the points along the plurality of objects.

The one or more processors to perform the one or more ray tracing operations can trace a plurality of rays from the camera to the plurality of objects in the environment, and determine that a subset of rays of the plurality of rays contact objects that are static. The one or more processors can record depths between the camera and the plurality of objects in the updated depth buffer based at least on each ray of the subset of rays contacting the first object in the path of the respective ray and the objects being static. The subset of rays can include a first subset of rays, and the one or more processors to perform the one or more ray tracing operations can forgo recording depths between the camera and the plurality of objects in the updated depth buffer based at least on each ray of a second subset of rays contacting the first object in the path of the respective ray and the object being static.

The one or more processors can perform operations including: determining tags the plurality of points associated with the plurality of objects in the environment. Each of the tags can indicate that a respective point is associated with a static object or a non-static object. The one or more processors can perform the one or more ray tracing operations for a current frame based at least on the acceleration structure of the previous frame and tags of the plurality of points.

In some aspects, the one or more processors can be included in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for generating or presenting at least one of augmented reality content, virtual reality content, or mixed reality content; a system for hosting one or more real-time streaming applications; a system for implementing large language models (LLMs); a system for implementing vision language models (VLMs); a system implementing one or more multi-modal language models; a system implemented using an edge device; a system implemented using a robot; a system for performing conversational AI operations; a system for performing generative AI operations; a system for generating synthetic data; a system incorporating one or more virtual machines (VMs); a system implemented at least partially in a data center; or a system implemented at least partially using cloud computing resources.

At least one aspect relates to a method. The method can include obtaining an acceleration structure based at least on performance of one or more ray tracing operations during generation of a previous frame. The acceleration structure can be associated with a plurality of points of a plurality of objects in an environment. The method can include determining an update to a position of a camera for a current frame relative to the plurality of objects in the environment, and generating a depth buffer representing distances between the camera and the plurality of points based at least on the update to the position of the camera. The method can include updating at least one object of the plurality of objects of the environment based at least on the distances.

The method can include generating a hierarchical depth buffer based at least on the depth buffer. The hierarchical depth buffer can include a reduced representation of the depth buffer. Updating the at least one object can include updating the at least one object based at least on the distances included in the hierarchical depth buffer by tessellating the at least one object in accordance with a tessellation rate.

### BRIEF DESCRIPTION OF THE DRAWINGS

The present systems and methods for generating images of cluster-based structures are described in detail below with reference to the attached drawing figures, wherein:

FIG. 1 is an example environment in which one or more devices operate to generate images of cluster-based structures, in accordance with some embodiments of the present disclosure;

FIGS. 2A-2D are example scenes involved in the generation of images of cluster-based structures, in accordance with some embodiments of the present disclosure.

FIG. 3 is a flow diagram of an example method for generating images of cluster-based structures, in accordance with some embodiments of the present disclosure;

FIG. 4 is a flow diagram of an example method for generating images of cluster-based structures based at least on ray tracing structured and unstructured microgeometry structures, in accordance with some embodiments of the present disclosure;

FIGS. 5A and 5B are a flow diagram showing an implementation for generating images of cluster-based structures based at least on ray tracing structured and unstructured microgeometry structures, in accordance with some embodiments of the present disclosure;

FIG. 6 is a flow diagram of an example method for reprojecting disoccluded pixels during ray tracing, in accordance with some embodiments of the present disclosure;

FIGS. 7A and 7B are a flow diagram showing an implementation for reprojecting disoccluded pixels during ray tracing, in accordance with some embodiments of the present disclosure;

FIG. 8 is a block diagram of an example content streaming system suitable for use in implementing some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed that are related to the generation of images of cluster-based structures. In some examples, methods for generating images of cluster-based structures can include receiving scene data associated with a scene (sometimes referred to as a virtual scene) of a three-dimensional (3D) environment. As used herein, cluster-based structures can refer to objects or any other features in a 3D environment that are formed of one or more primitives. The scene can represent a virtual environment that is created using 3D objects, lights, and a camera. In examples, a scene can include a plurality of objects positioned within the 3D environment to be generated. Objects can include any real-world object such as, for example, trees, leaves, streams, vehicles, people, and/or anything else that can be visually perceived. The objects in the 3D environment can be constructed from primitives. In examples, primitives can include two-dimensional (2D) and/or 3D primitives such as points, lines, polygons, triangles (e.g., micro-triangles), cubes, spheres, cones, cylinders, and so on. To generate the images, a camera can be placed within the 3D environment such that a viewpoint for the scene is directed toward the objects in the 3D environment. The objects can be further associated with multiple surfaces. For example, each object can be associated with a first surface and a second surface. In one example, the first surface of each object can be visible to the camera and the second surface of each object cannot be visible to the camera. Other examples are described in detail throughout this disclosure.

A system generating an image of the scene can determine a first set of surfaces and a second set of surfaces, each surface of the first set of surfaces and the second set of surfaces corresponding to the objects in the environment. In one example, the system can determine the first set of surfaces such that the first set of surfaces include the surfaces that are visible to the camera, and the second set of surfaces such that the second set of surfaces include surfaces that are not visible to the camera. In some embodiments, the surfaces of the objects in the 3D environment can be associated with (e.g., made of) a plurality of primitives. The system can then update the surfaces of the first set of surfaces and/or the second set of surfaces based at least on a classification associated with the first set of surfaces and/or the second set of surfaces. For example, the system can tessellate the first set of surfaces and/or the second set of surfaces (e.g., the primitives forming each surface of the first set of surfaces and/or the second set of surfaces) by increasing or decreasing the number of primitives for a given surface so as to improve the quality of the image of the scene while optimizing the available computing resources. The system can then generate an image based at least on updating the primitives of the first set of surfaces and/or the second set of surfaces.

By virtue of the implementation of the systems and methods disclosed herein, ray tracing can be performed for a scene based at least on the primitives of the first set of surfaces and/or the second set of surfaces being tessellated using varying tessellation factors. In one example, a tessellation factor can be set to a higher value for the primitives of surfaces that are closer to an origin (e.g., the camera) whereas a tessellation factor with a lower value can be used for the primitives of surfaces that are farther from the origin. Additionally, or alternatively, tessellation factors can be set based at least on, for example: whether the primitives of surfaces are visible or not visible from the origin, whether the primitives of surfaces are within a field of view associated with the origin (e.g., within a frustum projected from the origin into the scene), and/or whether distances to the primitives of the surfaces, compared to corresponding distances stored in a hierarchical Z-buffer, are lower than the distances to the primitives of other surfaces stored in the hierarchical Z-buffer, indicating that the primitives of a given surface are visible to the camera and not obscured by one or more other primitives.

By varying and updating the tessellation factor used to tessellate the primitives of a given surface based at least on these criteria, the primitives of surfaces that are more critical to, or otherwise that tend to be more impactful on, the photorealism of an image (e.g., closer surfaces, visible surfaces, etc.) can be tessellated at higher rates, resulting in higher resolution of such surfaces and/or the application of more realistic effects (e.g., improved shadow gradients, etc.) when compared to other surfaces that are less critical. This, in turn, reduces the computational requirements to generate a given image and allows for the allocation of available computational resources to generating targeted portions of the scene that have a greater impact on the overall photorealism of the scene.

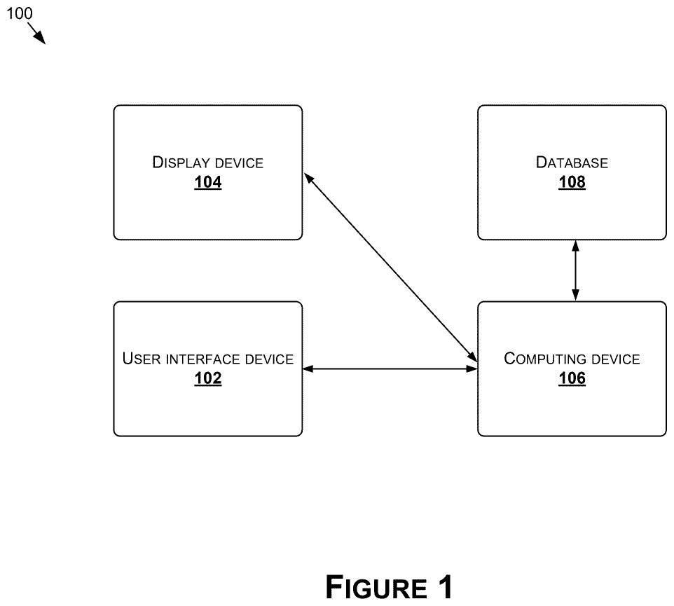

With reference to FIG. 1, FIG. 1 is an example environment 100, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory.

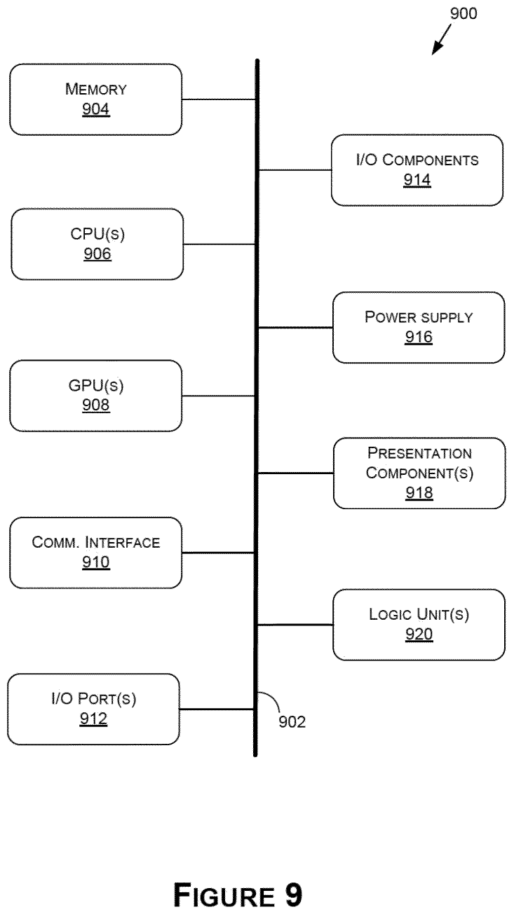

The environment 100 includes a user interface device 102, a display device 104, a computing device 106, and a database 108. In some embodiments, the user interface device 102, the display device 104, the computing device 106, and/or the database 108 can include one or more components that are the same as, or similar to, one or more components of the computing device 900 of FIG. 9. In some embodiments, one or more of the devices of FIG. 1 can interconnect via one or more wired and/or wireless connections, such interconnections corresponding to one or more networks as described herein.

In some embodiments, the user interface device 102 can include one or more devices configured to be in communication with the computing device 106. For example, the user interface device 102 can include one or more devices configured to be in wired and/or wireless communication with the computing device 106, thereby establishing wired and/or wireless communication connections with the computing device 106. In some embodiments, the user interface device 102 can include a device that is configured to be manipulated by an individual and generate signals representing such manipulation by the individual. The user interface device 102 can then transmit the signals to the computing device 106 via the one or more wired and/or wireless communication connections. In some embodiments, the user interface device can include one or more of: a keyboard, a mouse, a joystick, and/or the like.

In some embodiments, the display device 104 can include one or more devices configured to be in communication with the computing device 106. For example, the display device 104 can include one or more devices configured to be in wired and/or wireless communication with the computing device 106, thereby establishing wired and/or wireless communication connections with the computing device 106. In some embodiments, the display device 104 can include a device that is configured to output one or more images generated by the computing device 106. For example, the display device 104 can include a device such as a computer monitor, a touchscreen, a mobile device display (e.g., a smartphone display), and/or the like.

In some embodiments, the computing device 106 can include one or more devices configured to be in communication with the user interface device 102, the display device 104, and/or the database 108. For example, the computing device 106 can include one or more devices configured to be in wired and/or wireless communication with the user interface device 102, the display device 104, and/or the database 108, thereby establishing wired and/or wireless communication connections with the computing device 106. In some embodiments, the computing device 106 can include a device that is configured to generate data associated with one or more images, the data associated with the one or more images configured to cause the display device 104 to display the one or more images. For example, the computing device 106 can include a device such as a mobile device (e.g., smartphone), a laptop, a desktop, a server, and/or the like.

In some embodiments, the database 108 can include one or more devices configured to be in communication with the computing device 106. For example, the database 108 can include one or more devices configured to be in wired and/or wireless communication with the computing device 106, thereby establishing wired and/or wireless communication connections with the computing device 106. In some embodiments, the database 108 can include a device that is configured to store data described herein such as, for example, data associated with a scene, data associated with one or more images, and/or the like. For example, the database 108 can include a device such as a memory as described herein.

With continued reference to FIG. 1, the computing device 106 can obtain (e.g., receive) scene data associated with a scene of a 3D environment. For example, the computing device 106 can receive the scene data associated with the scene of the 3D environment, where the 3D environment is involved in the generation of one or more images the computing device 106 (e.g., using ray tracing techniques and/or the like). In examples, the computing device 106 can receive the scene data from one or more other devices of FIG. 1 (e.g., the database 108, the user interface device 102, and/or the display device 104), and/or from a memory of the computing device 106.

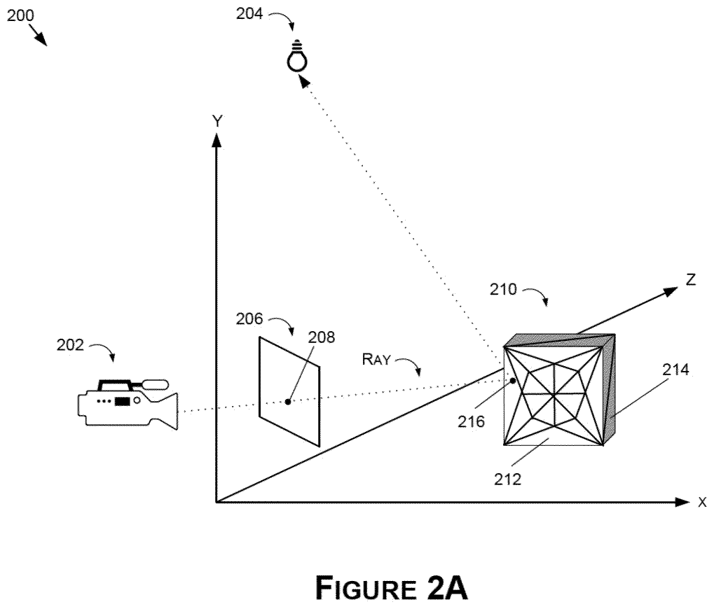

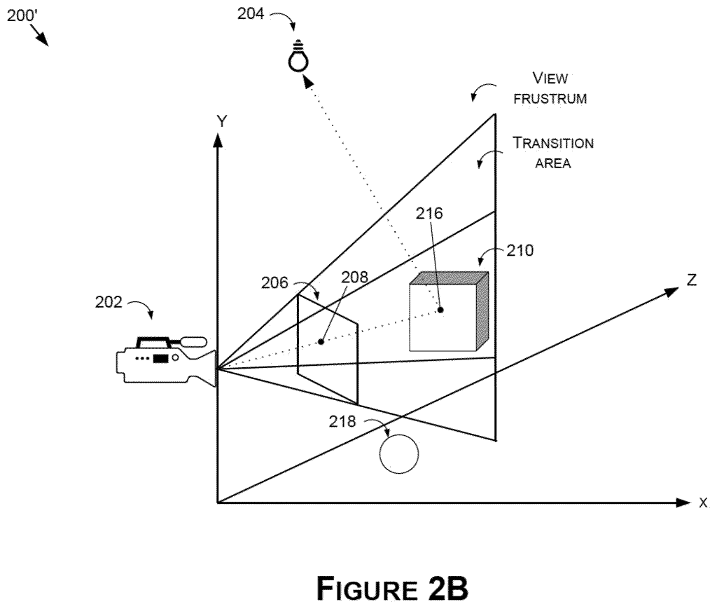

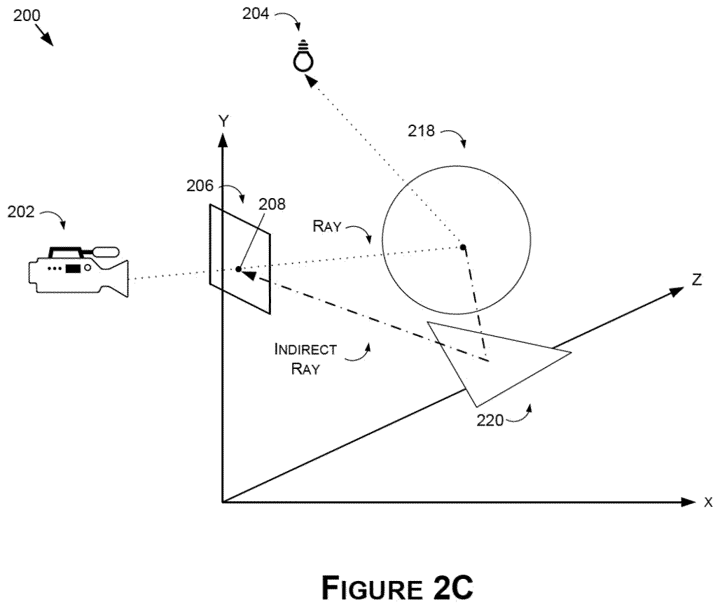

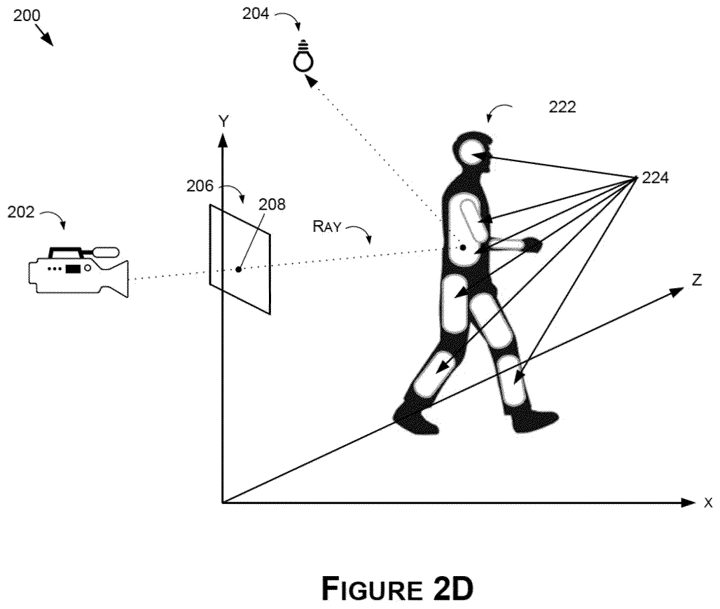

In some embodiments, the scene can include one or more objects placed in the 3D environment, a camera (e.g., a virtual camera placed at a point within the 3D environment), and one or more light sources placed in the 3D environment (e.g., one or more lights (e.g., light bulbs, lamps, overhead lights, and/or the like), the sun, and/or the like). In one example, and with reference to FIGS. 2A-2C, a scene 200 can include a camera 202, a light source 204, and one or more objects 210 (FIG. 2A, 2B), 218 (FIG. 2B), 218 and 220 (FIG. 2C) positioned within the 3D environment. In examples, the objects can be positioned and oriented relative to an X-Y-Z coordinate frame. When generating one or more images, a computing device 106 can cast rays from the camera 202 through each pixel of an image plane (referred to as an image 206) into portions of the 3D environment representing the scene 200. The computing device 106 can then trace the rays through the 3D environment to one or more light sources 204. Once the rays are traced through the 3D environment, the computing device 106 can calculate a color for each pixel based at least on the rays and/or corresponding light sources in the 3D environment. As illustrated by FIG. 2A, and as will be described in detail herein, the object 210 in the environment can have a first surface 212 and a second surface 214 that include (e.g., are formed by) a plurality of primitives. As illustrated, the primitives of the first surface 212 and the second surfaces 214 are tessellated using different tessellation factors. In this example, where surfaces 212 are visible to the camera 202 (e.g., where a ray can be traced through a point 208 of the image to a point 216 along the surface 212 of the object 210), the primitives of such surfaces 212 can be tessellated based at least on a higher tessellation factor than the primitives of surfaces 214 that are not visible to the camera 202. As a result, as shown in FIG. 2A, the surface 212 is formed with 20 primitives (e.g., triangles), and the surface 214 is formed with two primitives. It will be understood that a higher first tessellation factor and a lower second tessellation factor can be used to tessellate the primitives of surfaces in a scene. In examples, the higher tessellation factor can result in a higher number of corresponding primitives per surface and the lower tessellation factor can result in a lower number of corresponding primitives per surface. In some examples, one or more of the tessellation factors can be associated with decimation (the reduction of primitives) and, where both tessellation factors are associated with decimation, a higher first tessellation factor can result in a comparatively smaller decimation of primitives per surface as compared to the corresponding lower tessellation factor. For purposes of clarity, the primitives of the objects shown in FIGS. 2B and 2C are not expressly illustrated.

In some embodiments, the one or more objects can include anything that can be visually perceived within the 3D environment. For example, and without limitation, the one or more objects can include trees, leaves, streams, vehicles, people, boxes (e.g., boxes that are the same as, or similar to, object 210 of FIG. 2A), and/or the like. In some embodiments, each object of the one or more objects can be associated with one or more surfaces. For example, a box can be associated with a plurality of surfaces that form portions of the box (e.g., a top, bottom, and/or three or more sides of the box). In another example, a sphere can be associated with surfaces that form portions of the sphere (e.g., a first and second surface corresponding to a first and second hemisphere (respectively), a set of surfaces corresponding to a plurality of segments of the sphere, and/or the like). It will be understood that each surface described herein can be formed of one or more primitives.

In some embodiments, the computing device 106 can determine at least one primitive corresponding to one or more surfaces. For example, the computing device 106 can determine at least one primitive corresponding to each surface of the first set of surfaces and/or the second set of surfaces. In examples, some or all of the primitives can be updated based at least on one or more tessellation factors. For example, the primitives of a given set of surfaces can be tessellated by replacing the primitives with one or more different primitives, reducing the number of primitives, joining one or more primitives, eliminating one or more primitives, and/or the like based at least on the tessellation factor. In an example, where a first set of surfaces is associated with a tessellation factor that indicates the primitives of each of the surfaces in the set should be increased, the computing device 106 can increase the number of primitives for each surface by replacing the existing primitives with multiple, smaller primitives. This subdivision can improve the resulting image by increasing the number of primitives that are used to approximate the contours of a given surface. In another example, where a second set of surfaces is associated with a tessellation factor that indicates the primitives of each of the surfaces of the set should be decreased, the computing device 106 can decrease the number of primitives for each surface by replacing multiple primitives with a single primitive to reduce the number of surfaces involved in generating the resulting image. As described above, this enables the computing device 106 to adjust the level of detail for a given surface and, by extension, adjust the amount of computational resources used to perform ray tracing when generating the corresponding image.

In some embodiments, the computing device 106 can obtain scene data that causes the 3D environment to be updated. In one example, when generating images to be displayed in association with an interactive environment (e.g., a video game and/or the like), the computing device 106 can receive data from the user interface device 102 and/or the display device 104. The data received from the user interface device 102 and/or the display device 104 can be generated by the respective devices based at least on input provided by a user to the device, such interactions representing interactions between the user and the 3D environment. In one example, a user can move a user interface device 102 (e.g., a mouse) to cause a point of view of a character to change within the 3D environment. The data received from the user interface device 102 and/or the display device 104 can then be included with other scene data prior to the generation of images as described herein. While aspects of the present disclosure are discussed with respect to the generation of a single image, it will be understood that placement and movement of the camera, the image, and the objects within the 3D environment can cause the surfaces described herein to be iteratively updated, thereby ensuring that primitives of the respective surfaces are tessellated and subsequently rendered as images at resolutions that optimize the use of computing resources (e.g., processing of instructions, storage, read/writes to memory, and/or the like) by the computing device 106.

In some embodiments, the computing device 106 determines a first set of surfaces and a second set of surfaces. For example, the computing device 106 can determine the first set of surfaces and the second set of surfaces based at least on the scene data. The first set of surfaces and the second set of surfaces can each include one or more primitives that correspond to objects within the 3D environment. In some embodiments, the computing device 106 can determine the first set of surfaces and the second set of surfaces based at least on the position of the objects within the 3D environment relative to the camera. For example, the computing device 106 can determine the first set of surfaces and the second set of surfaces based at least on the computing device 106 determining that one or more of the surfaces included in the first set of surfaces or the second set of surfaces are within a field of view of the camera. In some embodiments, the field of view can be defined as an area within the 3D environment in which rays can be projected out through the image into the 3D environment, thereby forming a view frustum.

In some embodiments, the computing devices 106 can determine the first set of surfaces and the second set of surfaces based at least on the computing device 106 classifying the surfaces of the objects in the 3D environment. For example, the computing device 106 can classify the surfaces of the objects in the 3D environment based at least on the position of the objects within the 3D environment relative to the camera. Additionally, or alternatively, the computing device 106 can classify the surfaces of the objects in the 3D environment based at least on the position of the objects within the 3D environment relative to other objects within the 3D environment. The following examples are provided as examples of classifications of surfaces of objects within a 3D environment.

In an example, the computing device 106 can classify the surfaces of the objects in the 3D environment based at least on a distance between each surface and an origin associated with the camera. For example, the computing device 106 can determine the position and/or orientation of each object in the 3D environment relative to the camera. The computing device 106 can then determine whether each surface satisfies a first distance threshold and/or a second distance threshold as measured between at least a portion of the surface of the object and the origin of the camera. In this example, the first distance threshold can be associated with distances within a first range (e.g., from 0-5 feet, from 0-10 feet, and/or the like as measured within the 3D environment) and the second distance threshold can be associated with distances within a second range (e.g., greater than 5 feet, greater than 10 feet, and/or the like as measured within the 3D environment). The computing device 106 can then include the surfaces that satisfy the first distance threshold in the first set of surfaces and the surfaces that satisfy the second distance threshold in the second set of surfaces. As described herein, satisfying a threshold can refer to a value being greater than the threshold, more than the threshold, higher than the threshold, greater than or equal to the threshold, less than the threshold, fewer than the threshold, lower than the threshold, less than or equal to the threshold, equal to the threshold, and/or the like. In certain cases where a surface is perpendicular to an image, a distance to a point along the surface (e.g., a midpoint) and the camera can be used to determine whether the surface satisfies the first distance threshold or the second distance threshold. While the present disclosure is described with respect to a first distance threshold and second distance threshold, it will be understood that a plurality of distance thresholds can be used to separate the surfaces of objects in the 3D environment into corresponding sets of surfaces. Additionally, or alternatively, in examples, the computing device 106 can determine the tessellation factors associated with respective surfaces as a function based at least on an inverse square of a distance between an origin and a point along a surface of an object or any other suitable function that results in decreases in output values as distance increases (e.g., functions that determine tessellation factors based at least on projected lengths of edges, a field of view associated with a camera, and/or the like).

In an example, the computing devices 106 can classify the surfaces of the objects in the 3D environment as a forward-facing surface or not a forward-facing surface (e.g., a backward-facing surface that is not visible to a camera, surfaces within a transition area, and/or the like). For example, the computing devices 106 can determine a position and orientation of each object in the 3D environment relative to the camera. The computing device 106 can then determine that at least some of the surfaces of objects that are visible to the camera (e.g., in direct contact with one or more rays cast from the camera) are forward-facing surfaces and include the forward-facing surfaces in the first set of surfaces. The computing device 106 can also determine that at least some of the surfaces of each object that are not visible or are indirectly visible (e.g., visible to the camera in a reflection of one or more other surfaces within the 3D environment) to the camera are not forward-facing surfaces and include the not forward-facing surfaces in the second set of surfaces. In one example, as shown in FIG. 2A, the computing device 106 can determine that the object 210 includes a first surface 212 that is visible to the camera 202 and a second surface 214 that is not visible to the camera. The computing device 106 can then classify the first surface 212 as being a forward-facing surface and the computing device 106 can classify the second surface 214 as being a not forward-facing surface.

In another example, the computing device 106 can classify the surfaces of the objects in the 3D environment based at least on a volume of space within the scene. For example, the computing device 106 can determine the location of each surface relative to one or more volumes within the scene. A volume of space within a scene can include volumes associated with predetermined distances from the virtual position of the camera in the scene, volumes that are associated with one or more features of the 3D environment (e.g., a volume associated with a river, a volume associated with one or more trees, a volume associated with a building, and/or the like), volumes that are predetermined relative to the 3D environment, and/or the like. In an example, the computing device 106 can determine an acceleration structure for traversing the volumes during the performance of ray intersection tasks and operations. In this example, a first volume can correspond to a portion of an environment where primitives within the environment represented in an acceleration structure (e.g., a BVH) are enclosed by (e.g., partitioned by projection of) a view frustrum of a camera, and the second volume can correspond to a different portion of an environment (e.g., a second portion of the environment) used to generate the scene, where the second volume is not enclosed by the view frustrum (e.g., is to the left, right, above, or below relative to the view frustrum of the camera).

In examples, one or more volumes can correspond to volumes in the scene that include primitives projected from the 3D environment to the image (e.g., using a view frustrum) and one or more different volumes can correspond to volumes outside of the view frustum. For example, as illustrated in FIG. 2B, the contents (e.g., primitives) within a view frustum can be projected to the screen space of the camera 202 from the 3D environment. The view frustum can be projected from a volume in the scene 200 to the image 206 and encompass a first object 210 while not encompassing a second object 218. In this example, the surfaces of the first object 210 can be associated with a first set of surfaces and the surfaces of the second object 218 can be associated with a second set of surfaces. While the present disclosure is described with respect to a first volume and second volume, it will be understood that a plurality of volumes can be used to separate the surfaces of objects in the 3D environment into corresponding sets of surfaces. For example, one or more objects can be located within a transition area (see, e.g., the transition area of FIG. 2B) of a view frustum. In this example, surfaces of objects associated with the transition area of the view frustum can be associated with the first set of surfaces or the second set of surfaces described above, or a third set of surfaces. In examples where the surfaces of objects associated with the transition area are associated with a third set of surfaces, the surfaces of the objects associated with the transition area can be updated by tessellating the corresponding primitives of the surfaces associated with the transition area in accordance with a tessellation factor that is different from the first tessellation factor or the second tessellation factor as described above. In one example, the surfaces associated with the transition area can be tessellated in accordance with a tessellation factor that is between the first tessellation factor and the second tessellation factor described above, thereby resulting in a gradient in the number of primitives across comparable surfaces in the view frustum, in the transition area of the view frustum, and outside of the view frustum.

In another example, the computing device 106 can classify the surfaces of the objects in the 3D environment based at least on whether the surfaces of the objects are directly visible or indirectly visible to the camera. For example, the computing device 106 can determine that one or more surfaces of objects in a scene are directly visible by determining that a ray projected from the camera into the 3D environment onto a surface of the objects is directly traceable to a light source. In examples, the computing device 106 can determine that one or more surfaces of objects in the scene are not directly visible by determining that a ray projected from a camera into the 3D environment onto a surface of the object needs to be traced to the surface of another object before being traced to a light source. In this example, the surfaces that are directly visible can be associated with a first set of surfaces and the surfaces that are not directly visible can be associated with a second set of surfaces. In one example, as shown in FIG. 2C, the computing device 106 can determine that one or more surfaces of the object 218 are directly visible, whereas one or more surfaces of the object 220 are not directly visible (e.g., the rays projected to the surface of object 220 need to be traced to the surface of the object 218 much b).

In yet another example, the computing device 106 can classify the surfaces of the objects in the 3D environment based at least on the computing device 106 determining and/or maintaining a list of distances to points along surfaces of objects in the 3D environment in a Z-buffer and/or a hierarchical Z-buffer. For example, the computing device 106 can determine and maintain a Z-buffer and/or a hierarchical Z-buffer (e.g., in memory) based at least on the relative distances between pixels of an image captured by the camera and objects in the 3D environment. Z-buffers can be generated based at least on performance of one or more ray tracing operations when generating images as the objects and/or camera move at varying points in time. In this example, where the computing device 106 determines that a point along at least a portion of a surface of a first object is closer (e.g., visible) to the image as compared to one or more corresponding points along surfaces of that object and/or surfaces along a second object that are not represented by the Z-buffer and/or the hierarchical Z-buffer (e.g., generated during the rendering of a previous frame), the computing device 106 can classify at least a portion of the surface of the first object as being associated with a first set of surfaces and at least a portion of the surface of the second object as being associated with a second set of surfaces. In at least one example, where the first object includes a first box and the second object includes a second box that is behind the first box relative to the image, at least a portion of the surface corresponding to surfaces of the first box having distances that are closer to the camera can be associated with a first set of surfaces (e.g., surfaces that are visible to the camera) and at least a portion of the surface corresponding to surfaces of the second box having distances that are farther to the camera (e.g., surfaces that are not visible to the camera and for which no distance is available in the Z-buffer and/or hierarchical Z-buffer) can be associated with a second set of surfaces. It will be understood that the points compared can correspond to points along each of the surfaces of the objects in the 3D environment that are associated with a given ray cast from the camera into the 3D environment. In some embodiments, when the camera and/or the objects move within the 3D environment, the computing device 106 can update the hierarchical Z-buffer such that pixels can be tracked across multiple frames, and upon each iterative update, the surfaces in the scene can be reclassified based at least on the updates to the hierarchical Z-buffer. The primitives of the surfaces within the 3D environment can then be tessellated in accordance with the reclassification of the surfaces in accordance with the updated hierarchical Z-buffer.

In some embodiments, the computing device 106 can update the surfaces of the first set of surfaces and/or the second set of surfaces. For example, the computing device 106 can update the surfaces of the first set of surfaces and/or the second set of surfaces before generating an image of a scene. In another example, the computing device 106 can update the first set of surfaces and/or the second set of surfaces based at least on changes in position of the camera relative to the 3D environment. In an example, the computing device 106 can update the surface of the first set of surfaces and/or the second set of surfaces based at least on the computing device 106 iteratively reevaluating the classification of each surface in the 3D environment after a change in position of the camera relative to the 3D environment.

In some embodiments, the computing device 106 can update the surfaces of the first set of surfaces and/or the second set of surfaces based at least on a classification associated with the first set of surfaces and/or the second set of surfaces. For example, the computing device 106 can update the surfaces of the first set of surfaces and/or the second set of surfaces based at least on the computing device 106 classifying the surfaces of the objects in the 3D environment and associating the classified surfaces with either the first set of surfaces or the second set of surfaces. In some embodiments, once classified, the computing device 106 can update the first set of surfaces and/or the second set of surfaces by tessellating the primitives of the surfaces included in first set of surfaces and/or the primitives of the surfaces included in the second set of surfaces. For example, the computing device 106 can update the first set of surfaces and/or the second set of surfaces based at least on tessellation factors associated with the first set of surfaces and the second set of surfaces. In an example, the computing device 106 can determine a first tessellation factor for the first set of surfaces and a second tessellation factor for the second set of surfaces based at least on the computing device 106 determining that the first and second tessellation factors correspond to the classifications associated with the first and second sets of surfaces, respectively. The following examples are provided as examples of updates to surfaces of objects within a 3D environment.

In some examples, the computing device 106 can update the surfaces of the first set of surfaces and/or the surfaces of the second set of surfaces based at least on at least one (e.g., each) surface of the first set of surfaces being classified as forward-facing surfaces and one or more (e.g., each) surface of the second set of surfaces being classified as not forward-facing surfaces. For example, the computing device 106 can determine that the first tessellation factor corresponds to the classification of surfaces of the first set of surfaces as being forward-facing surfaces. The computing device 106 can then update the surfaces of the first set of surfaces by tessellating the primitives of one or more (e.g., each) of the surfaces of the first set of surfaces based at least on a first tessellation factor. In examples, the computing device 106 can determine that the second tessellation factor corresponds to the classification of surfaces of the second set of surfaces as being not forward-facing surfaces (e.g., surfaces that are not visible to the camera). The computing device 106 can then update the surfaces of the second set of surfaces by tessellating the primitives of one or more (e.g., each) of the surfaces of the second set of surfaces based at least on a second tessellation factor. In these examples, to improve the quality of the image generated by the computing device 106, the first tessellation factor can include a value that is greater than the second tessellation factor, and the primitives associated with the first set of surfaces can be updated such that a greater number of primitives form the surfaces of the first set of surfaces as compared to comparable surfaces of the second set of surfaces. This can result in the computing device 106 generating images where, by virtue of the selective tessellation of primitives of the first set of surfaces and/or the second set of surfaces, the first set of surfaces that are visible to the camera are illustrated in a higher resolution than the second set of surfaces which can be indirectly visible or not at all visible to the camera.

In some examples, the computing device 106 can update the surfaces of the first set of surfaces and/or the surfaces of the second set of surfaces based at least on at least one (e.g., each) surface of the first set of surfaces being classified as satisfying a first distance threshold and at least one (e.g., each) surface of the second set of surfaces being classified as satisfying a second distance threshold. For example, the computing device 106 can determine that the first tessellation factor corresponds to the classification of surfaces of the first set of surfaces as satisfying the first distance threshold. The computing device 106 can then update the surfaces of the first set of surfaces by tessellating the primitives of the first set of surfaces based at least on a first tessellation factor. In examples, the computing device 106 can determine that the second tessellation factor corresponds to the classification of surfaces of the second set of surfaces as satisfying the second distance threshold. The computing device 106 can then update the surfaces of the second set of surfaces by tessellating the primitives of the first set of surfaces based at least on a second tessellation factor. In these examples, to improve the quality of the image generated by the computing device 106, the first tessellation factor can include a value that is greater than the second tessellation factor, and the first set of surfaces can be updated such that a greater number of primitives form the surfaces of the first set of surfaces as compared to comparable surfaces of the second set of surfaces. In this way, where the first distance threshold corresponds to distances that are closer to the camera as compared to the second distance threshold, the surfaces of objects closer to the camera can be formed by the computing device 106 using a greater number of primitives. This can result in the computing device 106 generating images where the first set of surfaces that are closer to the camera are illustrated at a higher resolution than the second set of surfaces which are farther from the camera.

In some examples, the computing device 106 can update the surfaces of the first set of surfaces and/or the surfaces of the second set of surfaces based at least on at least one (e.g., each) surface of the first set of surfaces being classified as being located in a first volume of the scene and at least one (e.g., each) surface of the second set of surfaces being classified as being located in a second volume of the scene. For example, the computing device 106 can determine that the first tessellation factor corresponds to the classification of surfaces of the first set of surfaces as being located in a first volume of the scene. The computing device 106 can then update the surfaces of the first set of surfaces by tessellating the primitives of the first set of surfaces based at least on a first tessellation factor. In examples, the computing device 106 can determine that the second tessellation factor corresponds to the classification of surfaces of the second set of surfaces as being located in a second volume of the scene. The computing device 106 can then update the surfaces of the second set of surfaces by tessellating the primitives of the first set of surfaces based at least on a second tessellation factor. In these examples, to improve the quality of the image generated by the computing device 106, the first tessellation factor can include a value that is greater than the second tessellation factor, and the first set of surfaces can be updated such that a greater number of primitives form the surfaces of the first set of surfaces as compared to comparable surfaces of the second set of surfaces. In this way, where the first volume of the scene corresponds to distances that are closer to the camera, closer to a particular point such as a focal point or area of interest, etc., as compared to the second volume of the scene, the surfaces of objects in the first volume of the scene can be formed by the computing device 106 using a greater number of primitives. This can result in the computing device 106 generating images where the first set of surfaces that are located in the first volume of the scene are illustrated in a higher resolution than the second set of surfaces which are in the second volume of the scene.

In some examples, the computing device 106 can update the surfaces of the first set of surfaces and/or the surfaces of the second set of surfaces based at least on at least one (e.g., each) surface of the first set of surfaces being classified as being closer the (virtual) position of the camera and at least one (e.g., each) surface of the second set of surfaces being classified as being farther (e.g., behind) a corresponding surface of the first set of surfaces. For example, the computing device 106 can determine that the first tessellation factor corresponds to the classification of surfaces of the first set of surfaces. The computing device 106 can then update the surfaces of the first set of surfaces by tessellating the primitives of the first set of surfaces based at least on a first tessellation factor. In examples, the computing device 106 can determine that the second tessellation factor corresponds to the classification of surfaces of the second set of surfaces scene. The computing device 106 can then update the surfaces of the second set of surfaces by tessellating the primitives of the second set of surfaces based at least on a second tessellation factor. In these examples, to improve the quality of the image generated by the computing device 106, the first tessellation factor can include a value that is greater than the second tessellation factor, and the first set of surfaces can be updated such that a greater number of primitives form the surfaces of the first set of surfaces as compared to comparable surfaces of the second set of surfaces. In this way, the surfaces of objects closer to the image generated by the camera (e.g., as determined independently or based at least on distances stored in a Z-buffer) can be formed by the computing device 106 using a greater number of primitives. This can result in the computing device 106 generating images where the first set of surfaces that are not obscured in the image by any other surfaces are illustrated in a higher resolution than the second set of surfaces.

In some embodiments, the computing device 106 can update the surfaces of the first set of surfaces and/or the second set of surfaces by tessellating the primitives of the respective surfaces based at least on a plurality of classifications associated with the first set of surfaces and/or the second set of surfaces. For example, the computing device 106 can update the surfaces of the first set of surfaces and/or the second set of surfaces by tessellating the primitives of the respective surfaces based at least on the computing device 106 classifying the surfaces of the objects in the 3D environment and associating the classified surfaces with either the first set of surfaces or the second set of surfaces. In one example, where a first surface is classified as satisfying a first distance threshold and as being located in a first volume, the computing device 106 can determine the corresponding tessellation factors for the object and determine a final tessellation factor for the first surface based at least on the corresponding tessellation factors. This can be done, for example, by averaging the corresponding tessellation factors. The computing device 106 can then update the surfaces of the first set of surfaces by tessellating the primitives of the respective surfaces based at least on the final tessellation factor. This can be done for one or more surfaces of one or more objects in the 3D environment. In this way, the computing device 106 can apply multiple metrics to a given surface to determine a final tessellation factor for that given surface. In some embodiments, the computing device 106 can determine the final tessellation factor based at least on a scalar value. For example, the computing device 106 can determine the final tessellation factor by multiplying a given tessellation factor (or, in examples, the final tessellation factor) by a scalar value to determine and/or update the final tessellation factor. The computing device 106 can then tessellate the surfaces within the 3D environment based at least on these tessellation factors.

As described above, embodiments of the present disclosure can include classifying one or more surfaces of a 3D environment iteratively across multiple frames as the one or more objects and/or the camera move within the 3D environment. For example, the computing device 106 can build an acceleration structure such as a bounding volume hierarchy by first determining a bounding volume for at least one (e.g., each) object in the 3D environment. The bounding volume associated with at least one (e.g., each) object can include, for example, a bounding box, a bounding sphere, and/or the like. The computing device 106 can then determine (e.g., build) the acceleration structure such as a tree (referred to sometimes as a bounding volume hierarchy tree or “BVH tree”) based at least on the bounding volumes in the 3D environment. For example, the computing device 106 can determine a tree where each node at the end of the tree (the leaves of the tree) correspond to the bounding volume of each object in the 3D environment. While bounding boxes are described as encompassing objects included in the 3D environment, in some instances objects can be divided into smaller objects and the bounding volumes associated with the smaller objects. In one example, as shown in FIG. 2D, in the case of a human 222, the arms, legs, and/or torso of the human 222 can be associated with capsules 224 that are positioned internal relative to the surfaces of the human 222. These capsules 224 can be used as a proxy for the position of the corresponding surfaces of the arms, legs, and/or the like, and the computing device 106 can generate the BHV tree based at least on the position of these capsules 224. In this way, the surfaces of the portions of the humans, animals, and/or other objects with highly-complex surface structures can be classified as described herein, and the corresponding primitives forming such surfaces, as well as the primitives that are behind such surfaces that are not directly visible to the camera, can be tessellated in accordance with the classifications.

The computing device 106 can then determine groupings of bounding volumes corresponding to objects and organize the groupings according to one or more nodes. For example, where multiple objects in the 3D environment are clustered into a first cluster and a second cluster, the computing device 106 can associate the objects in the first cluster with a first node, and the computing device 106 can associate the objects in the second cluster with a second node.

In some embodiments, the computing device 106 can use the resulting tree to classify the surfaces in the 3D environment. For example, the computing device 106 can use the BVH tree to determine whether surfaces within the 3D environment are, for example, forward-facing surfaces or not forward-facing surfaces based at least on whether rays cast into the 3D environment intersect a leaf or any of the nodes associated with a leaf of the BVH tree. Additionally, or alternatively, the computing device 106 can use the resulting tree to determine whether the surfaces are visible or not visible from the camera. In this example, the computing device 106 can then obtain the distances to the surfaces that are visible from a Z-buffer maintained by the computing device 106 (described above) and classify the surfaces in the 3D environment based at least on the classification of the surfaces. When generating an image for a frame at time t=0 (e.g., at a specific point in time), the computing device 106 can use the BVH tree and/or the Z-buffer from one or more earlier frames at times earlier that time t=0 (e.g., time t=−1, −2, and/or the like). As a result, the computing device 106 can classify the surfaces within the 3D environment using information generated for previous frames, thereby conserving resources when classifying surfaces within the 3D environment.

In some embodiments, the computing device 106 can generate an image based at least on the first set of surfaces and the second set of surfaces. For example, the computing device 106 can generate an image based at least on the computing device 106 updating the primitives of the first set of surfaces and/or the second set of surfaces. In some embodiments, the computing device 106 can generate the image by determining the first set of surfaces and the second set of surfaces that are to be included in the scene representing the 3D environment. The computing device 106 can then cast rays from the camera (e.g., from the origin associated with the camera) through each pixel of an image into the 3D environment. In the case where the rays intersect with objects in the 3D environment, the computing device 106 can determine the point at which the rays intersect with the primitives that are comprised by the surfaces of the objects as well as rays from such points toward one or more light sources within the 3D environment. Once the light sources emitting light are identified, the computing device 106 can calculate a final color (e.g., pixel value) for each pixel. For example, the computing device 106 can calculate the final color based at least on an intensity of the light emitted by the light source and received at the point along the surfaces of the objects, how the object scatters the light received from the light sources, how the object reflects the light received from the light sources, how the object refracts (e.g., bends) the light received from the light source, and/or the like. In examples, the computing device 106 can also calculate the final color based at least on whether one or more shadows are being cast by other surfaces within the 3D environment at the points for which the pixel color is being calculated.

In some embodiments, the computing device 106 can generate data associated with the image of the scene. For example, the computing device 106 can generate data associated with the image of the scene that is configured to cause the display device 104 to display the image as an output. The computing device 106 can then provide (e.g., transmit and/or the like) the data associated with the image of the scene to one or more of the devices of FIG. 1. For example, the computing device 106 can then provide the data associated with the image of the scene to the display device 104 to cause the display device 104 to display the image. In examples, the computing device 106 can provide the data associated with the image of the scene to the database 108.

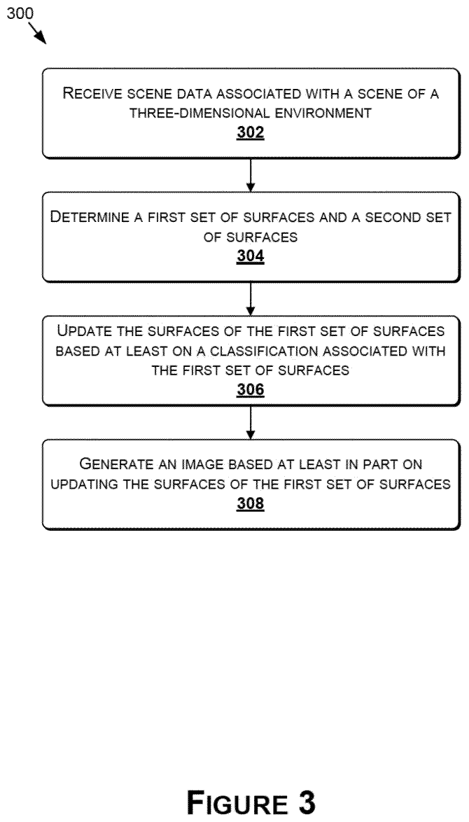

Now referring to FIG. 3, each block of method 300, described herein, comprises a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), as an application programming interface (API) into an application or service, or a plug-in to another product, to name a few. In addition, method 300 is described, by way of example, with respect to the environment of FIG. 1. However, this method can additionally or alternatively be executed by any one system, or any combination of systems, including, but not limited to, those described herein.

FIG. 3 is a flow diagram showing a method 300 for generating images of cluster-based structures, in accordance with some embodiments of the present disclosure. The method 300, at block 302, includes receiving scene data associated with a scene of a 3D environment. For example, a computing device (e.g., a computing device that is the same as, or similar to, the computing device 106 of FIG. 1) can receive the scene data associated with the scene of the 3D environment. In some embodiments, the scene can include a plurality of objects. For example, the scene can include a plurality of objects located at a plurality of corresponding positions (locations and orientations) within the 3D environment. The positions can be described with respect to an X-Y-Z coordinate frame and/or any other suitable coordinate frame.

In some embodiments, each object of the plurality of objects can include one or more surfaces. For example, a box in the 3D environment (e.g., a box that is the same as, or similar to, the object 210 of FIG. 2A) can be included in the 3D environment and formed by six sides. In some embodiments, the one or more surfaces can be further formed by one or more primitives (e.g., microgeometries). For example, the box can be formed of a plurality of triangles and/or any other suitable primitives as described herein.

The method 300, at block 304, includes determining a first set of surfaces and a second set of surfaces. For example, the computing device can determine a first set of surfaces and a second set of surfaces. In some embodiments, each surface of the first set of surfaces and the second set of surfaces can be associated with corresponding objects within the 3D environment and include (e.g., be formed by) one or more primitives. In this example, the computing device can further determine the one or more primitives that correspond to one or more surfaces of the first set of surfaces and/or the second set of surfaces.

In some embodiments, the computing device can classify one or more surfaces of the first set of surfaces and/or the second set of surfaces. In one example, the computing device can classify one or more surfaces in the 3D environment as forward-facing surfaces or not forward-facing surfaces. In another example, the computing device the computing device can classify one or more surfaces in the 3D environment as satisfying a first distance threshold or a second distance threshold. In this example, the first distance threshold and/or the second distance threshold can be associated with distances from an origin (e.g., of a camera within the 3D environment) to a point along the surface where a ray projected from the origin intersects with a primitive of the given surface. In yet another example, the computing device can classify one or more surfaces in the 3D environment as located in a first volume of a scene or a second volume of a scene. In this example, the computing device can classify the one or more surfaces as located in the first volume of the scene, where the first volume is further associated with an area within the 3D environment, and the computing device can classify the one or more surfaces as located in the second area of the scene, where the second area is further associated with a different area within the 3D environment. In another example, the computing device can classify the one or more surfaces in the 3D environment based at least on a distance between the origin of the camera and points along the one or more surfaces as represented in a Z-buffer. For example, the computing device can determine the position of each object within the 3D environment and generate and/or maintain a Z-buffer of the distances to points along the surfaces of each object. The computing device can then classify the one or more surfaces in the 3D environment based at least on the distance from the origin to the points along the surfaces of each object and associate the one or more surfaces with the first set of surfaces or the second set of surfaces. In each of these examples, the computing device can associate the first set of surfaces with a first tessellation factor and the second set of surfaces with a second tessellation factor. For example, the computing device can associate each surface of the first set of surfaces with the first tessellation factor and/or each surface of the second set of surfaces with the second tessellation factor. The computing device can then tessellate the primitives of each of the surfaces based at least on the tessellation factors associated with the corresponding surfaces, as described herein.

The method 300, at block 306, includes updating the surfaces of the first set of surfaces based at least on a classification associated with the first set of surfaces. For example, the computing device can update the surfaces of the first set of surfaces by tessellating the primitives of each of the surfaces of the first set of surfaces. During tessellation, the computing device can increase or decrease the number of primitives associated with a given surface by adding, removing, dividing, joining, etc., one or more primitives of the given surface. Additionally, or alternatively, the method can include updating the surfaces of the second set of surfaces based at least on a classification associated with the second set of surfaces. For example, the computing device can update the surfaces of the second set of surfaces based at least on a classification associated with the second set of surfaces by tessellating the primitives of each of the surfaces of the second set of surfaces. During tessellation, the computing device can increase or decrease the number of primitives associated with a given surface by adding, removing, dividing, joining, etc., one or more primitives of the given surface. In these examples, the computing device can update the surfaces of the first set of surfaces and/or the second set of surfaces based at least on the first tessellation factor or the second tessellation factor. For example, the computing device can update the surfaces of the first set of surfaces by tessellating the primitives of the surfaces of the first set of surfaces based at least on the first tessellation factor. In examples, the computing device can update the surfaces of the second set of surfaces by tessellating the primitives of the surfaces of the second set of surfaces based at least on the second tessellation factor. Where the first tessellation factor is greater than the tessellation factor, the first set of surfaces can be tessellated such that the surfaces include a greater number of primitives than comparable surfaces (e.g., surfaces of similar sizes) of the second set of surfaces.

The method 300, at block 308, includes generating an image based at least on updating the surfaces of the first set of surfaces. For example, the computing device can generate an image based at least on the first set of surfaces and the second set of surfaces. For example, the computing device can generate the image based at least on the computing device 106 updating the primitives of the first set of surfaces and/or the second set of surfaces. In some embodiments, the computing device can generate the image by determining the first set of surfaces and the second set of surfaces that are to be included in the scene representing the 3D environment. The computing device can then cast rays from the camera through each pixel of an image into the 3D environment. In the case where the rays intersect with objects in the 3D environment, the computing device can determine the point at which the rays intersect with the primitives that are comprised by the surfaces of the objects as well as rays from such points toward one or more light sources within the 3D environment. Once the light sources transmitting light are identified, the computing device can calculate a final color for each pixel. In examples, the computing device can also calculate the final color based at least on whether one or more shadows are being cast by other surfaces within the 3D environment at the points for which the pixel color is being calculated.

In some embodiments, the computing device can generate data associated with the image of the scene. For example, the computing device can generate data associated with the image of the scene that is configured to cause a display device (e.g., a display device that is the same as, or similar to, the display device 104 of FIG. 1) to display the image as an output. The computing device can then provide the data associated with the image of the scene to cause the display device to display the image. In examples, the computing device can provide the data associated with the image of the scene to the database.

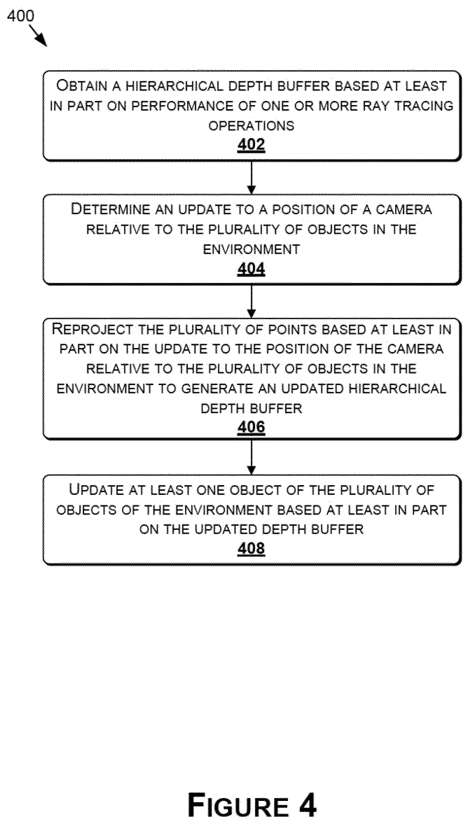

Now referring to FIG. 4, each block of method 400, described herein, comprises a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few. In addition, method 400 is described, by way of example, with respect to the environment of FIG. 1. However, this method can additionally or alternatively be executed by any one system, or any combination of systems, including, but not limited to, those described herein.

FIG. 4 is a flow diagram showing a method 400 for generating images of cluster-based structures based at least on ray tracing microgeometry structures, in accordance with some embodiments of the present disclosure. The method 400, at block 402, includes obtaining a depth buffer (also referred to as a Z-buffer) based at least on performance of one or more ray tracing operations. For example, a computing device (e.g., a computing device that is the same as, or similar to, the computing device 106 of FIG. 1) can obtain the Z-buffer based at least on performance of one or more ray tracing operations at a first point in time that involve a camera as described herein. In examples, the computing device can be the same computing device that performs the one or more ray tracing operations (e.g., a computing device that is the same as, or similar to, the computing device 106 of FIG. 1).

In some embodiments, the Z-buffer can be processed to generate a hierarchical Z-buffer. For example, the computing device can reduce the plurality of points represented in the Z-buffer one or more times (e.g., in accordance with a parallel reduction operator) to form a hierarchical depth buffer (Hi-Z buffer) that includes multiple levels of resolution that form a reduced representation of the depth buffer. This reduction can be performed based at least on the computing device determining a maximum depth value over recursive tiles to obtain the hierarchical Z-buffer. By virtue of generating a hierarchical Z-buffer, the computing device can check which part(s) of an object in the environment are occluded by looking up depths across the levels of the hierarchical Z-buffer.

The method 400, at block 404, includes determining an update to a position of a camera relative to the plurality of objects in the environment. For example, the computing device can receive input that indicates a change in a position of the camera relative to objects in the environment. The change can be based at least on input causing a character to move within the environment, input that causes repositioning of the camera independent of movement of the character, and/or the like. In some examples, the input provided by a user device, a program coordinating execution of operations involved in rendering images when generating a video, and/or the like.

In some embodiments, the plurality of objects can include at least one proxy object. For example, the plurality of objects can include at least one proxy object that correspond(s) to at least one portion of an object in the environment. In one example, the proxy object can include a capsule (e.g., a capsule that is the same as, or similar to, the capsules 224 of FIG. 2D. The capsule can be associated with (e.g., enclosed by) one or more a surface as described herein. As an example, a capsule can be enclosed by primitives forming a torso of a character moving through an environment. While described as a capsule positioned with respect to a character being rendered while moving through an environment, it will be understood that the proxy objects described herein can form any suitable shape (e.g., spheres, cubes, and/or the like) and can be enclosed by any object in the environment in which ray tracing operations are being performed.

In some embodiments, the plurality of objects can be dynamic objects and static objects. For example, the plurality of objects can include a character moving through the environment. In this example, the character is a dynamic object given that the character can move independently within the environment relative to both the camera and the other objects of the plurality of objects. In examples, the plurality of objects can include rocks and/or buildings that do not move through the environment. In this example, the rocks and/or buildings are static objects given that the rocks and/or buildings cannot move independently within the environment.

In some embodiments, the computing device can receive input that indicates a change in a position of the camera relative to a dynamic object in the environment and determine an updated position of the camera relative to the dynamic object. For example, when animated, the dynamic object can move independently within the environment relative to the camera. In this example, the computing device can determine an update to the position of the camera relative to the dynamic object based at least on animation (motion) of the dynamic object within the environment. In some embodiments, as the dynamic object moves within the environment, the computing device can determine the movement of a proxy object corresponding to the dynamic object. For example, as the dynamic object moves, the computing device can determine the movement of corresponding proxy objects (capsules and/or the like) as proxies for the geometry of the dynamic object. In this way, the computing device can reduce the complexity associated with building acceleration structures as the complexity of a given dynamic object increases.

The method 400, at block 406, includes reprojecting the plurality of points based at least on the update to the position of the camera relative to the plurality of objects in the environment to generate an updated depth buffer. For example, as described with respect to block 402, the computing device can obtain a depth buffer (also referred to as a Z-buffer) based at least on performance of one or more ray tracing operations. In some embodiments, the computing device can obtain the depth buffer based at least on motion of one or more objects relative to one another and/or the camera within the environment (e.g., at a later point in time as compared to the earlier-generated depth buffer). For example, as one or more characters are animated or as the position of the camera moves within the environment, the computing device can reproject the plurality of points and then obtain the updated depth buffer. In this example, the updated depth buffer can represent distances to surfaces of objects that are visible to the camera.

In some embodiments, the computing device can generate a hierarchical Z-buffer based at least on reprojecting the plurality of points of the updated depth buffer. For example, the computing device can reduce the plurality of points represented in the Z-buffer as described herein one or more times to form an updated hierarchical Z-buffer that includes multiple levels of resolution. In this example, the hierarchical Z-buffer can include one or more layers that represent the environment at resolutions that are less than a resolution of the updated depth buffer.

The method 400, at block 408, includes updating at least one object of the plurality of objects of the environment based at least on the updated depth buffer. For example, the computing device can determine that the at least one object is visible to the camera based at least on the updated hierarchical Z-buffer. In this example, the computing device can update one or more primitives of the at least one object. For example, the computing device can tessellate primitives of the at least one object based at least on the computing device determining that the at least one object is visible. In this example, where the object is visible, the computing device can tessellate the primitives of the at least one object such that one or more individual primitives of the at least one object are replaced by two or more individual primitives.

Additionally, or alternatively, the computing device can determine that the at least one object is at least not visible to the camera. For example, the computing device can determine that the at least one object is occluded by another object (e.g., by one or more capsules passing in front of the object when within the field of view of the camera). In this example, the computing device can determine that the at least one object is not visible to the camera based at least on the updated hierarchical Z-buffer. In some embodiments, the computing device can tessellate the primitives of the at least one object that is not visible based at least on a tessellation factor that causes decimation of the primitives. For example, the computing device can tessellate the primitives of the at least one object that is not visible based at least on a tessellation factor that causes decimation of the primitives where two or more adjacent primitives are replaced with a single primitive. In this way, the computing device can reduce the number of primitives that are involved in the one or more ray tracing operations when the one or more objects are not visible to the camera (e.g., are occluded by objects within the environment, are not in a field of view of the camera for one or more frames, and/or the like).

In some embodiments, the computing device can perform one or more ray tracing operations at a second point in time. For example, the computing device can perform the one or more ray tracing operations based at least on (e.g., after) updating objects of the plurality of objects. In this example, the computing device can perform the one or more ray tracing operations such that the computing device generates one or more images representing the objects in the environment relative to the camera.

As will be understood, the computing device can iteratively repeat one or more of the operations as described herein with respect to blocks 402-408. For example, the computing device can iteratively determine updates to the one or more objects in the environment (e.g., animations and/or the like) and perform the operations described herein to generate corresponding images. In some embodiments, data associated with the images can be provided to one or more display devices (e.g., a display device that is the same as, or similar to, the display device 104 of FIG. 1). For example, the data associated with the images can be configured to cause the one or more display devices to display the images and provide the data associated with the images to the display device.

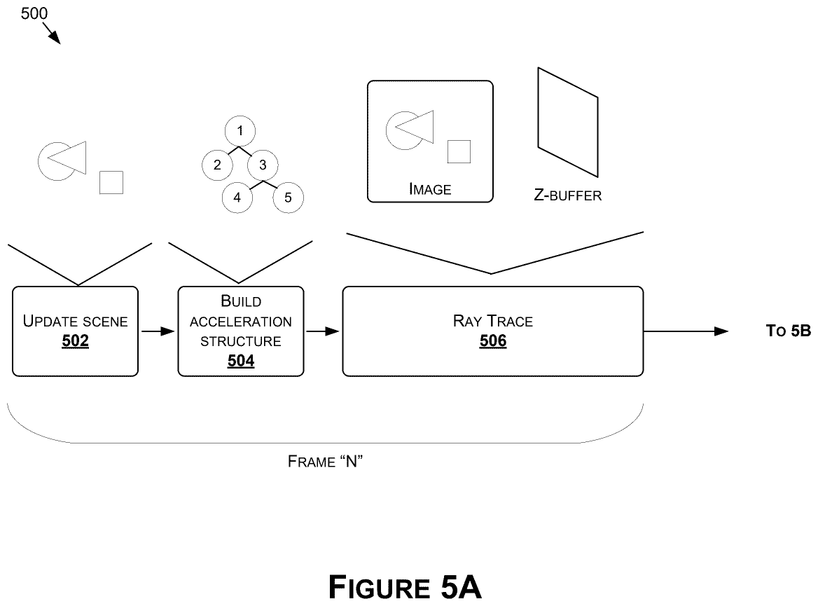

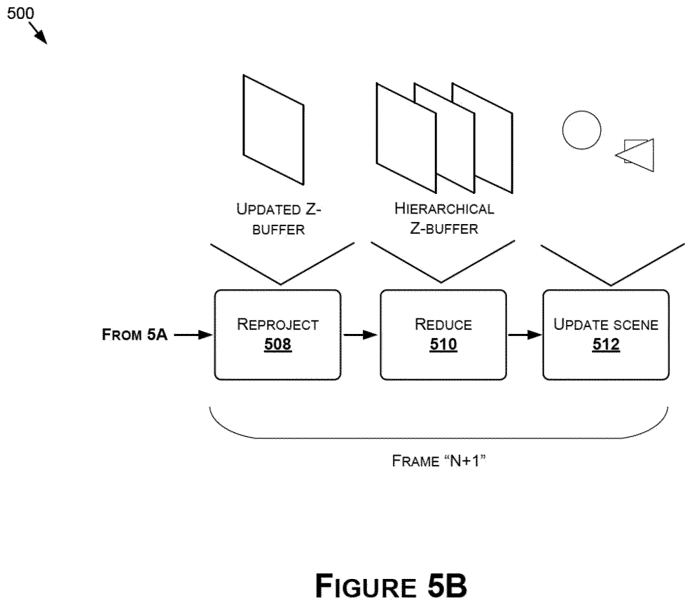

Now referring to FIGS. 5A and 5B, each block of implementation 500, described herein, comprises a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few. In addition, implementation 500 is described, by way of example, with respect to the environment of FIG. 1. However, this method can additionally or alternatively be executed by any one system, or any combination of systems, including, but not limited to, those described herein.

FIGS. 5A and 5B are a flow diagram showing an implementation 500 for generating images of cluster-based structures based at least on ray tracing microgeometry structures, in accordance with some embodiments of the present disclosure. The implementation 500, at block 502, includes updating a scene. For example, a computing device (e.g., a computing device that is the same as, or similar to, computing device 106 of FIG. 1) can update a scene such as a virtual scene in which one or more characters and/or objects are positioned relative to a camera. The update to the scene can include positioning the one or more objects within the environment and relative to viewpoint of the camera.

The implementation 500, at block 504, includes building an acceleration structure. For example, the computing device can build an acceleration structure such as a BVH based at least on the positions of the objects in the environment relative to the camera.

The implementation 500, at block 506, includes performing one or more ray tracing operations. For example, the computing device can perform the one or more ray tracing operations, where the ray tracing operations involve tracing rays from an origin (e.g., a point along a lens of the camera) through the environment to one or more surfaces, and ultimately to a light source. As will be understood, the tracing of rays can be based at least on the acceleration structure, and the computing device can forgo tracing certain rays based at least on whether the objects the rays would be directed to are visible, as indicated by the acceleration structure.

In some embodiments, the computing device can update the primitives of the objects involved in the one or more ray tracing operations. For example, prior to or during a performance of the one or more ray tracing operations, the computing device can update one or more surfaces of the one or more objects (e.g., based at least on the computing device determining a tessellation factor) within the environment. The computing device can then perform the one or more ray tracing operations based at least on the updated objects.

The implementation 500, at block 506, includes generating an image and a depth buffer (or Z-buffer). For example, the computing device can generate an image based at least on the performance of the one or more ray tracing operations. Additionally, the computing device can generate the Z-buffer based at least on the computing device determining distances to the surfaces of one or more objects in the environment while performing the one or more ray tracing operations.

The implementation 500, at block 508, the computing device can implement one or more reprojection techniques as objects move within the environment relative to the camera between frames to track the pixels of the camera from the previous camera position to the current camera position. And, by virtue of the movement of the camera and/or objects relative to the camera, the Z-buffer cannot include information for all the pixels (“disocclusions”) that result from object surfaces coming into the field of view of the camera. For example, where a camera and/or objects are moved horizontally (within the field of view of the camera), the newly-visible (e.g., disoccluded) pixels are rendered. In this example, depending on the objects in the scene and rate of tessellation used to update the visible surfaces, this reprojection technique can allow for reductions in certain examples from 100 million primitives (triangles) down to 25 million primitives.

The implementation 500, at block 510, includes reducing the Z-buffer. For example, the computing device can implement a reduction to the data in the Z-buffer. In an example, the computing device can implement the reduction by computing a maximum depth value(s) over recursive tiles to obtain a hierarchical Z-buffer. The hierarchical Z-buffer can allow the computing device to determine (e.g., check) which part(s) of an object are occluded by looking up a depth associated with single pixel across one or more hierarchy levels (as you go up in the hierarchy levels, each pixel covers a larger volume of the field of view of the camera).

The implementation 500, at block 512, includes updating the scene. For example, the computing device can update the scene by determining one or more updated positions for one or more of the objects in the scene (either visible or not visible to the camera).

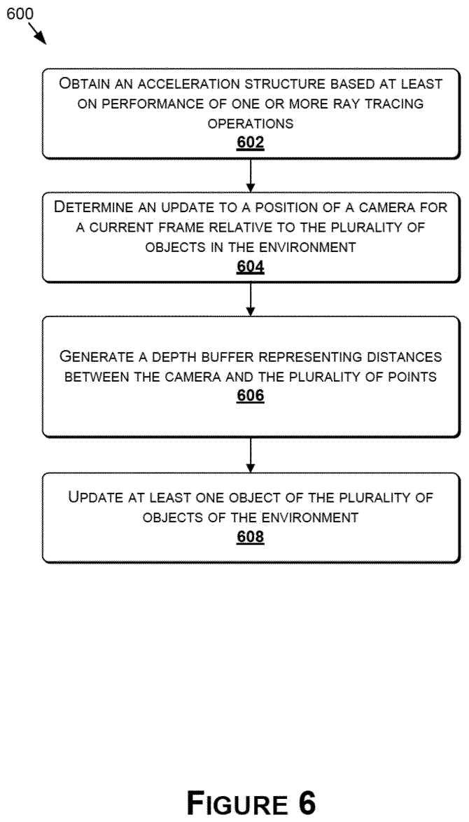

Now referring to FIG. 6, each block of method 600, described herein, comprises a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few. In addition, method 600 is described, by way of example, with respect to the environment of FIG. 1. However, this method can additionally or alternatively be executed by any one system, or any combination of systems, including, but not limited to, those described herein.

FIG. 6 is a flow diagram showing a method 600 for reprojecting disoccluded pixels during ray tracing, in accordance with some embodiments of the present disclosure. The method 600, at block 602, includes obtaining an acceleration structure based at least on performance of one or more ray tracing operations (e.g., of a light transport simulation pipeline). For example, a computing device (e.g., a computing device that is the same as, or similar to, the computing device 106 of FIG. 1) can perform (e.g., execute) the one or more ray tracing operations and obtain an acceleration structure. In this example, the computing device can obtain the acceleration structure for the generation of a current frame based at least on the performance of the one or more ray tracing operations when generating a previous frame. The acceleration structure used to perform the ray tracing operations for the previous frame can be associated with a plurality of points that correspond to a plurality of objects in an environment. For example, the acceleration structure can include a BVH that includes information about points such as vertices of primitives forming objects in an environment.

The method 600, at block 604, includes determining an update to a position of a camera for a current frame relative to the plurality of objects in the environment. For example, the computing device that obtains the acceleration structure can determine the update to the position of the camera. The update to the position of the camera can be based at least on movement of the camera and/or one or more objects within the environment. For example, the update can be based at least on movement of the camera within the environment relative to objects within the environment. In some examples, when viewed from the camera, the objects can change position relative to one another such that a first object can move and disocclude (e.g., reveal) points of objects that were previously behind the first object. In examples, when viewed from the camera, the objects can change in position and/or pose relative to the camera (e.g., turn and/or the like) such that points of the object that were previously not visible to the camera are disoccluded (e.g., become visible).

The method 600, at block 606, includes generating a depth buffer (Z-buffer) representing distances between the camera and the plurality of points. For example, the computing device can generate the Z-buffer representing the distances between the camera and the plurality of points based at least on the update to the position of the camera and the position of the objects of the environment relative to the camera. In this example, the Z-buffer can include an array that represents distances from a camera involved in generating images to points along surfaces of objects in the environment.

In some embodiments, the computing device can generate the Z-buffer for a current frame based at least on an acceleration structure associated with a previous frame. For example, as the environment changes and a scene is updated based at least on movement of the camera and objects within the environment, the computing device can execute one or more operations that are part of a ray tracing or other light transport simulation pipeline to generate a current frame. A subset of these operations can be associated with the generation of acceleration structures such as BVHs as described herein. In some embodiments, the computing device can generate the Z-buffer based at least on these acceleration structures that were generated by the computing device for the previous frame. In some examples, the computing device can record depths from the camera to the points along the plurality of objects in the environment. When recording the depths, the computing device can determine that each respective depth corresponds to a first object that was in the path of the respective ray as the ray was projected from the camera into the environment in accordance with the view frustrum.

In some embodiments, when generating the Z-buffer the computing device can trace the plurality of rays from the camera to the points along the objects (e.g., first objects) in the environment based at least on the points being tagged as static or not static. For example, the computing device can obtain the acceleration structure for the previous frame and determine that one or more objects are static (e.g., did not move between the previous frame and the current frame relative to the environment) or not static (e.g., moved relative to the environment). This determination can be made independently of the portions of the ray tracing pipeline described herein. For example, the computing device can execute one or more other operations (e.g., in response to user input received during execution of a computer game by the computing device, in response to animation of objects when rendering a video, and/or the like) that result in changes in position of the objects within the environment and determine the objects that are static and non-static. The computing device can tag each point corresponding to the objects as static or not static based at least on the computing device monitoring these changes in position of the objects. In this example, the computing device can then trace the plurality of rays from the camera to the static objects and record the depths between the camera and the objects in the Z-buffer, where the rays that are recorded correspond to points on the static objects. In this example, the static objects can also be the first objects to be contacted by the respective rays through the ray tracing process.

Additionally, or alternatively, the computing device that generates the Z-buffer can forgo recording depths between the camera and the objects in the Z-buffer, where the rays that are recorded correspond to points on non-static objects. For example, the computing device can determine whether a given point corresponds to an object that is tagged as being static or non-static and, where the determination indicates that the given point is a non-static object (e.g., a dynamic or animated object), the computing device can forgo recording the depths to the corresponding points of the non-static objects. In this way, the computing device can significantly reduce or eliminate the chances of disocclusions occurring due to camera movement and/or object movement (e.g., objects becoming visible based at least on object animation) that need to be processed separately during the ray tracing process. More specifically, by performing ray tracing operations to identify objects that are the first objects to be contacted by a ray extending from a camera into a scene using an acceleration structure from a previous frame, the computing device can quickly generate Z-buffers and determine distances to the objects that are visible to the camera in a current frame. This can reduce the chances of over-tessellation of objects in a given scene, reducing the amount of memory that needs to be reserved to represent the objects (e.g., in association with a BVH) during the ray tracing process.

In some embodiments, the Z-buffer can be processed to generate a hierarchical depth buffer (hierarchical Z-buffer). For example, the computing device can reduce the plurality of points represented in the Z-buffer one or more times (e.g., in accordance with a parallel reduction operator as described herein) to form a hierarchical Z-buffer) that includes multiple levels of resolution. This reduction can be performed based at least on the computing device determining a maximum depth value over recursive tiles to obtain the hierarchical Z-buffer. By virtue of generating a hierarchical Z-buffer, the computing device can check which part(s) of an object in the environment are occluded by looking up depths across the levels of the hierarchical Z-buffer.

The method 600, at block 608, includes updating at least one object of the plurality of objects of the environment. For example, the computing device can update the at least one object of the plurality of objects of the environment based at least on the hierarchical Z-buffer. The computing device can determine that the at least one object is at least visible to the camera based at least on the updated hierarchical Z-buffer. In this example, the computing device can then update one or more primitives of the at least one object. For example, the computing device can tessellate primitives of the at least one object based at least on the computing device determining that the at least one object is visible. In this example, where at least part of the object is visible, the computing device can tessellate the primitives of the at least one object (e.g., the part(s) of the object that are visible) such that one or more individual primitives of the at least one object are replaced by a greater number (e.g., two or more) of individual primitives.

Additionally, or alternatively, the computing device can determine that at least a part of the at least one object is not visible to the camera. For example, the computing device can determine that the at least one object is occluded by another object (e.g., by one or more capsules passing in front of the object when within the field of view of the camera). In this example, the computing device can determine that the part(s) of the at least one object are not visible to the camera based at least on the updated hierarchical Z-buffer. In some embodiments, the computing device can tessellate the primitives of the part(s) of the at least one object that is not visible based at least on a tessellation factor that causes decimation of the primitives. For example, the computing device can tessellate the primitives of the part(s) of the at least one object that is not visible based at least on a tessellation factor that causes decimation of the primitives where two or more adjacent primitives are replaced with a lower number of primitives. In this way, the computing device can reduce the number of primitives that are involved in the one or more ray tracing operations when the one or more objects are not visible to the camera (e.g., are occluded by objects within the environment, are not in a field of view of the camera for one or more frames, and/or the like).

In some embodiments, the computing device can perform one or more ray tracing operations at a second point in time. For example, the computing device can perform the one or more ray tracing operations based at least on (e.g., after) updating objects of the plurality of objects. In this example, the computing device can perform the one or more ray tracing operations such that the computing device generates one or more images representing the objects in the environment relative to the camera.

As will be understood, the computing device can iteratively repeat one or more of the operations as described herein with respect to blocks 602-608. For example, the computing device can iteratively determine updates to the one or more objects in the environment (e.g., animations and/or the like) and perform the operations described herein to generate corresponding images. In some embodiments, data associated with the images can be provided to one or more display devices (e.g., a display device that is the same as, or similar to, the display device 104 of FIG. 1). For example, the data associated with the images can be configured to cause the one or more display devices to display the images and provide the data associated with the images to the display device.

In some embodiments, the Z-buffer can be processed to generate a hierarchical Z-buffer. For example, the computing device can reduce the plurality of points represented in the Z-buffer one or more times (e.g., in accordance with a parallel reduction operator) to form a hierarchical depth buffer (Hi-Z buffer) that includes multiple levels of resolution. This reduction can be performed based at least on the computing device determining a maximum depth value over recursive tiles to obtain the hierarchical Z-buffer. By virtue of generating a hierarchical Z-buffer, the computing device can check which part(s) of an object in the environment are occluded by looking up depths across the levels of the hierarchical Z-buffer.

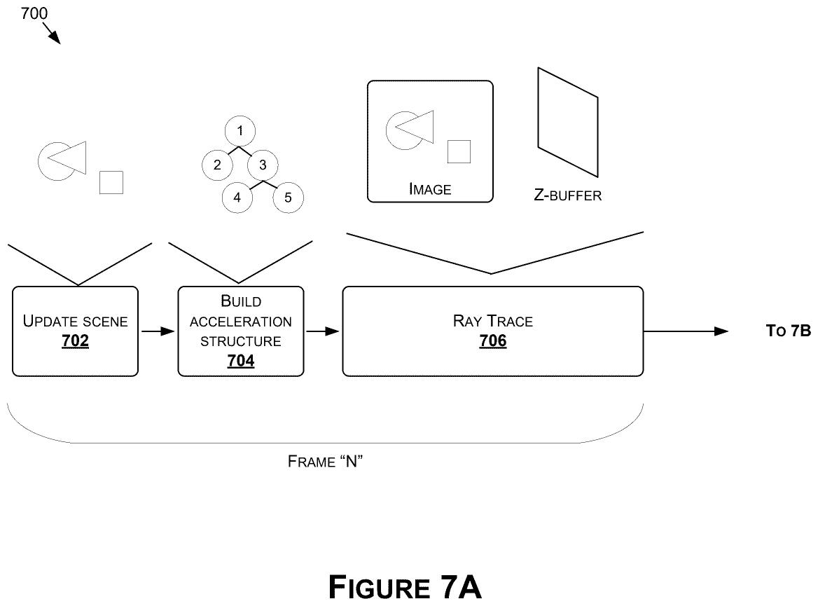

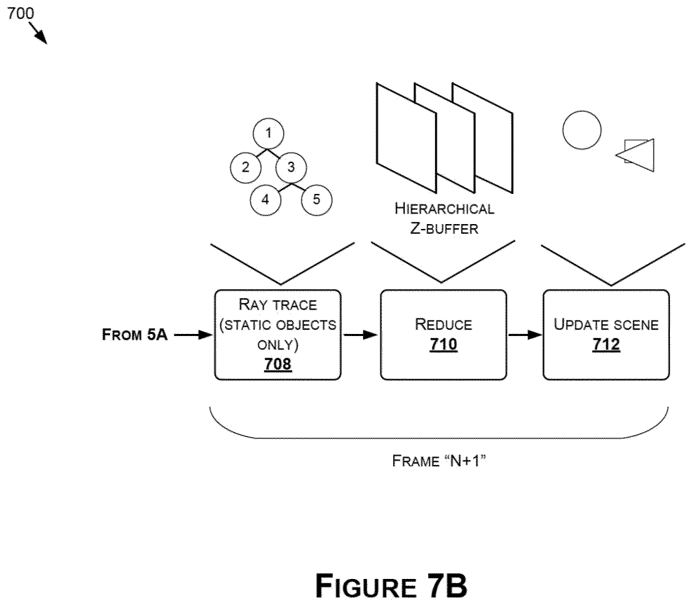

Now referring to FIGS. 7A and 7B, each block of implementation 700, described herein, comprises a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), as an API to an application or service, or a plug-in to another product, to name a few. In addition, implementation 700 is described, by way of example, with respect to the environment of FIG. 1. However, this method can additionally or alternatively be executed by any one system, or any combination of systems, including, but not limited to, those described herein.

FIGS. 7A and 7B are a flow diagram showing an implementation 700 for reprojecting disoccluded pixels, in accordance with some embodiments of the present disclosure. The implementation 700, at block 702, includes updating a scene. For example, a computing device (e.g., a computing device that is the same as, or similar to, computing device 106 of FIG. 1) can update a scene such as a virtual scene in which one or more characters and/or objects are positioned relative to a camera. The update to the scene can include (re) positioning the one or more objects within the environment and relative to the camera.

The implementation 700, at block 704, includes building an acceleration structure. For example, the computing device can build an acceleration structure such as a BVH based at least on the positions of the objects in the environment relative to the camera.

The implementation 700, at block 706, includes performing one or more ray tracing operations. For example, the computing device can perform the one or more ray tracing operations (also referred to as a first set of ray tracing operations), where the first set of ray tracing operations involve tracing rays from an origin (e.g., a point along a lens of the camera) through the environment to one or more surfaces, and ultimately to a light source. As will be understood, the tracing of rays can be based at least on the acceleration structure, and the computing device can forgo tracing certain rays based at least on whether the objects the rays would be directed to are visible as indicated by the acceleration structure.

In some embodiments, the computing device can update the primitives of the objects involved in the one or more ray tracing operations. For example, prior to or during performing the one or more ray tracing operations, the computing device can update one or more surfaces of the one or more objects (e.g., based at least on the computing device determining a tessellation factor) within the environment. The updates can be determined based at least in part on the generation of a hierarchical Z-buffer as described herein. The computing device can then perform the one or more ray tracing operations based at least on the updated objects.

Performing the one or more ray tracing operations can include generating an image and a depth buffer (or Z-buffer). For example, the computing device can generate an image based at least on the performance of the one or more ray tracing operations. Additionally, the computing device can generate the Z-buffer based at least on the computing device determining distances to the surfaces of one or more objects in the environment while performing the one or more ray tracing operations.

The implementation 700, at block 708, as objects move within the environment relative to the camera between frames, the computing device can implement one or more ray tracing operations to identify any pixels that were disoccluded when compared to previous frames in a sequence of frames and represent the objects in the Z-buffer. For example, where a camera and/or objects are moved horizontally (within the field of view of the camera), the disoccluded pixels can become visible to the camera. The computing device can then perform a second set of ray tracing operations to identify depths to objects where the objects are the first objects to be encountered by rays projected from the camera.

The implementation 700, at block 710, includes reducing the Z-buffer. For example, the computing device can implement a reduction to the data in the Z-buffer. In an example, the computing device can implement the reduction by computing a maximum depth values over recursive tiles to obtain a hierarchical Z-buffer. The hierarchical Z-buffer can allow the computing device to determine (e.g., check) which part(s) of an object are occluded by looking up a depth associated with single pixel across one or more hierarchy levels (e.g., for each higher level of the hierarchy levels, each pixel covers an increasingly larger volume of the field of view of the camera).

The implementation 700, at block 712, includes updating the scene. For example, the computing device can update the scene by determining one or more updated positions for one or more of the objects in the scene (either visible or not visible to the camera). The implementation 700 can then be iteratively repeated for a number of iterations until there are no more frames to be rendered.

### Example Content Streaming System

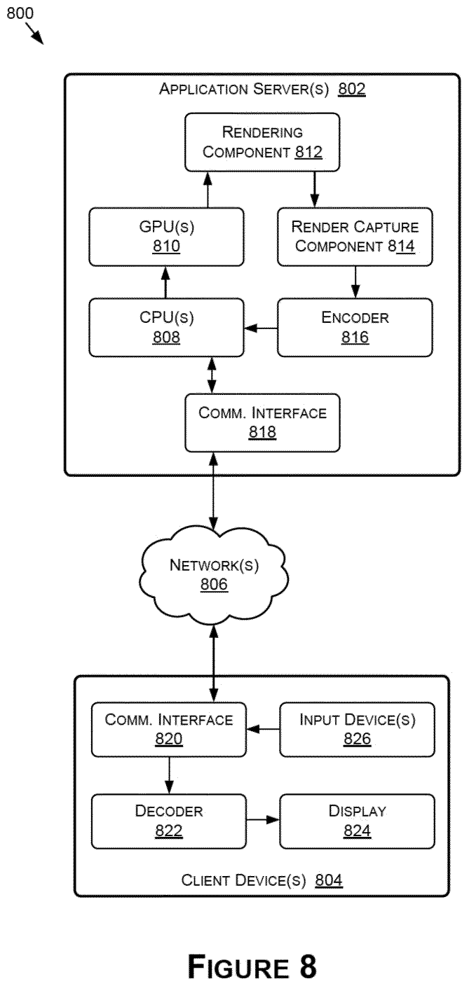

Now referring to FIG. 8, FIG. 8 is an example system diagram for a content streaming system 800, in accordance with some embodiments of the present disclosure. FIG. 8 includes application server(s) 802 (which can include similar components, features, and/or functionality to the example computing device 900 of FIG. 9), client device(s) 804 (which can include similar components, features, and/or functionality to the example computing device 900 of FIG. 9), and network(s) 806 (which can be similar to the network(s) described herein). In some embodiments of the present disclosure, the system 800 can be implemented. The application session can correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 800, for an application session, the client device(s) 804 can only receive input data in response to inputs to the input device(s), transmit the input data to the application server(s) 802, receive encoded display data from the application server(s) 802, and display the display data on the display 824. As such, the more computationally intense computing and processing is offloaded to the application server(s) 802 (e.g., rendering-icular ray or path tracing—for graphical output of the application session is executed by the GPU(s) of the game server(s) 802). In other words, the application session is streamed to the client device(s) 804 from the application server(s) 802, thereby reducing the requirements of the client device(s) 804 for graphics processing and rendering.

For example, with respect to an instantiation of an application session, a client device 804 can be displaying a frame of the application session on the display 824 based at least on receiving the display data from the application server(s) 802. The client device 804 can receive an input to one of the input device(s) and generate input data in response. The client device 804 can transmit the input data to the application server(s) 802 via the communication interface 820 and over the network(s) 806 (e.g., the Internet), and the application server(s) 802 can receive the input data via the communication interface 818. The CPU(s) can receive the input data, process the input data, and transmit data to the GPU(s) that causes the GPU(s) to generate a rendering of the application session. For example, the input data can be representative of a movement of a character of the user in a game session of a game application, firing a weapon, reloading, passing a ball, turning a vehicle, etc. A rendering component can render the application session (e.g., representative of the result of the input data) and the render capture component 814 can capture the rendering of the application session as display data (e.g., as image data capturing the rendered frame of the application session). The rendering of the application session can include ray or path-traced lighting and/or shadow effects, computed using one or more parallel processing units-such as GPUs, which can further employ the use of one or more dedicated hardware accelerators or processing cores to perform ray or path-tracing techniques—of the application server(s) 802. In some embodiments, one or more virtual machines (VMs)—e.g., including one or more virtual components, such as vGPUs, vCPUs, etc.—can be used by the application server(s) 802 to support the application sessions. An encoder 816 can then encode the display data to generate encoded display data and the encoded display data can be transmitted to the client device 804 over the network(s) 806 via the communication interface 818. The client device 804 can receive the encoded display data via the communication interface 820 and the decoder 822 can decode the encoded display data to generate the display data. The client device 804 can then display the display data via the display 824.

The systems and methods described herein can be used for a variety of purposes, by way of example and without limitation, for machine control, machine locomotion, machine driving, synthetic data generation, model training/updating, perception, augmented reality, virtual reality, mixed reality, robotics, security and surveillance, ray tracing, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments can be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for ray tracing, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Computing Device

FIG. 9 is a block diagram of an example computing device(s) 900 suitable for use in implementing some embodiments of the present disclosure. Computing device 900 can include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 can comprise one or more virtual machines (VMs), and/or any of the components thereof can comprise virtual components (e.g., virtual hardware components). For non-limiting examples, one or more of the GPUs 908 can comprise one or more vGPUs, one or more of the CPUs 906 can comprise one or more vCPUs, and/or one or more of the logic units 920 can comprise one or more virtual logic units. As such, a computing device(s) 900 can include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, can be considered an I/O component 914 (e.g., if the display is a touch screen). As another example, the CPUs 906 and/or GPUs 908 can include memory (e.g., the memory 904 can be representative of a storage device in addition to the memory of the GPUs 908, the CPUs 906, and/or other components). In other words, the computing device of FIG. 9 is merely an example. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 can represent one or more links or busses, such as an address bus, a data bus, a control bus, or a combination thereof. The interconnect system 902 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 can be directly connected to the memory 904. Further, the CPU 906 can be directly connected to the GPU 908. Where there is direct, or point-to-point connection between components, the interconnect system 902 can include a PCIe link to carry out the connection. In these examples, a PCI bus need not be included in the computing device 900.

The memory 904 can include any of a variety of computer-readable media. The computer-readable media can be any available media that can be accessed by the computing device 900. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 904 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 906 can be configured to execute at least some of the computer-readable instructions to control one or more components of the computing device 900 to perform one or more of the methods and/or processes described herein. The CPU(s) 906 can each include one or more cores (e.g., one, two, four, eight, twenty-eight, seventy-two, etc.) that are capable of handling a multitude of software threads simultaneously. The CPU(s) 906 can include any type of processor, and can include different types of processors depending on the type of computing device 900 implemented (e.g., processors with fewer cores for mobile devices and processors with more cores for servers). For example, depending on the type of computing device 900, the processor can be an Advanced RISC Machines (ARM) processor implemented using Reduced Instruction Set Computing (RISC) or an x86 processor implemented using Complex Instruction Set Computing (CISC). The computing device 900 can include one or more CPUs 906 in addition to one or more microprocessors or supplementary co-processors, such as math co-processors.

In addition to or alternatively from the CPU(s) 906, the GPU(s) 908 can be configured to execute at least some of the computer-readable instructions to control one or more components of the computing device 900 to perform one or more of the methods and/or processes described herein. One or more of the GPU(s) 908 can be an integrated GPU (e.g., with one or more of the CPU(s) 906 and/or one or more of the GPU(s) 908 can be a discrete GPU. In embodiments, one or more of the GPU(s) 908 can be a coprocessor of one or more of the CPU(s) 906. The GPU(s) 908 can be used by the computing device 900 to render graphics (e.g., 3D graphics) or perform general purpose computations. For example, the GPU(s) 908 can be used for General-Purpose computing on GPUs (GPGPU). The GPU(s) 908 can include hundreds or thousands of cores that are capable of handling hundreds or thousands of software threads simultaneously. The GPU(s) 908 can generate pixel data for output images in response to rendering commands (e.g., rendering commands from the CPU(s) 906 received via a host interface). The GPU(s) 908 can include graphics memory, such as display memory, for storing pixel data or any other suitable data, such as GPGPU data. The display memory can be included as part of the memory 904. The GPU(s) 908 can include two or more GPUs operating in parallel (e.g., via a link). The link can directly connect the GPUs (e.g., using NVLINK) or can connect the GPUs through a switch (e.g., using NVSwitch). When combined together, each GPU 908 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 906 and/or the GPU(s) 908, the logic unit(s) 920 can be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 can discretely or jointly perform any combination of the methods, processes and/or portions thereof. One or more of the logic units 920 can be part of and/or integrated in one or more of the CPU(s) 906 and/or the GPU(s) 908 and/or one or more of the logic units 920 can be discrete components or otherwise external to the CPU(s) 906 and/or the GPU(s) 908. In embodiments, one or more of the logic units 920 can be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 can include one or more receivers, transmitters, and/or transceivers that enable the computing device 900 to communicate with other computing devices via an electronic communication network, included wired and/or wireless communications. The communication interface 910 can include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 can include one or more data processing units (DPUs) to transmit data received over a network and/or through interconnect system 902 directly to (e.g., a memory of) one or more GPU(s) 908.

The I/O ports 912 can enable the computing device 900 to be logically coupled to other devices including the I/O components 914, the presentation component(s) 918, and/or other components, some of which can be built in to (e.g., integrated in) the computing device 900. I/O components 914 include a microphone, mouse, keyboard, joystick, game pad, game controller, satellite dish, scanner, printer, wireless device, etc. The I/O components 914 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and/or touch recognition (as described in more detail below) associated with a display of the computing device 900. The computing device 900 can include depth cameras, such as stereoscopic camera systems, infrared camera systems, RGB camera systems, touchscreen technology, and/or combinations of these, for gesture detection and recognition. Additionally, the computing device 900 can include accelerometers or gyroscopes (e.g., as part of an inertia measurement unit (IMU)) that enable detection of motion. In some examples, the output of the accelerometers or gyroscopes can be used by the computing device 900 to render immersive augmented reality or virtual reality.

The power supply 916 can include a hard-wired power supply, a battery power supply, or a combination thereof. The power supply 916 can provide power to the computing device 900 to enable the components of the computing device 900 to operate.

The presentation component(s) 918 can include a display (e.g., a monitor, a touch screen, a television screen, a heads-up-display (HUD), other display types, or a combination thereof), speakers, and/or other presentation components. The presentation component(s) 918 can receive data from other components (e.g., the GPU(s) 908, the CPU(s) 906, DPUs, etc.), and output the data (e.g., as an image, video, sound, etc.).

### Example Data Center

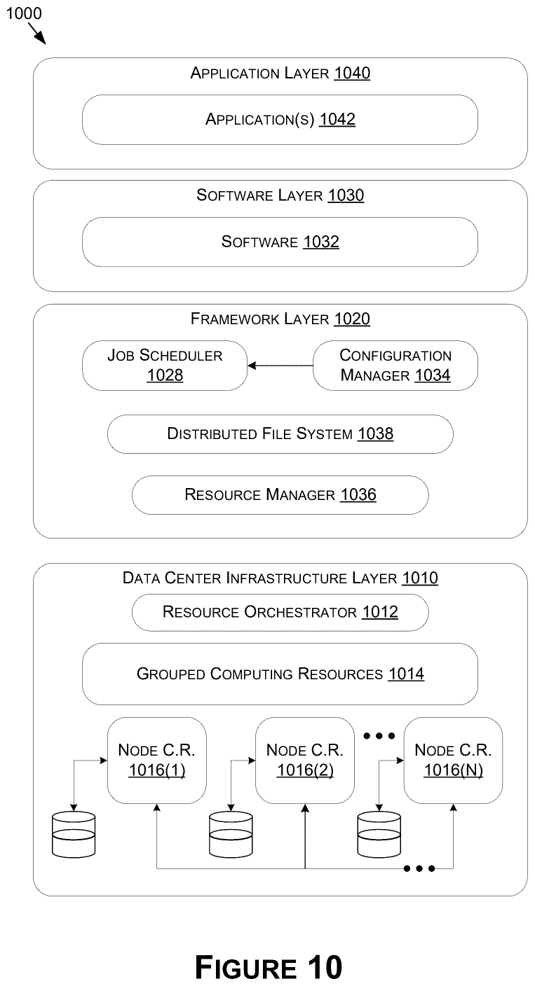

FIG. 10 illustrates an example data center 1000 that can be used in at least one embodiments of the present disclosure. The data center 1000 can include a data center infrastructure layer 1010, a framework layer 1020, a software layer 1030, and/or an application layer 1040.

As shown in FIG. 10, the data center infrastructure layer 1010 can include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) can correspond to a server having one or more of the above-mentioned computing resources. In addition, in some embodiments, the node C.R.s 1016(1)-1016(N) can include one or more virtual components, such as vGPUs, vCPUs, and/or the like, and/or one or more of the node C.R.s 1016(1)-1016(N) can correspond to a virtual machine (VM).

In at least one embodiment, grouped computing resources 1014 can include separate groupings of node C.R.s 1016 housed within one or more racks (not shown), or many racks housed in data centers at various geographical locations (also not shown). Separate groupings of node C.R.s 1016 within grouped computing resources 1014 can include grouped compute, network, memory or storage resources that can be configured or allocated to support one or more workloads. In at least one embodiment, several node C.R.s 1016 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 1012 can configure or otherwise control one or more node C.R.s 1016(1)-1016(N) and/or grouped computing resources 1014. In at least one embodiment, resource orchestrator 1012 can include a software design infrastructure (SDI) management entity for the data center 1000. The resource orchestrator 1012 can include hardware, software, or some combination thereof.

In at least one embodiment, as shown in FIG. 10, framework layer 1020 can include a job scheduler 1028, a configuration manager 1034, a resource manager 1036, and/or a distributed file system 1038. The framework layer 1020 can include a framework to support software 1032 of software layer 1030 and/or one or more application(s) 1042 of application layer 1040. The software 1032 or application(s) 1042 can respectively include web-based service software or applications, such as those provided by Amazon Web Services, Google Cloud and Microsoft Azure. The framework layer 1020 can be, but is not limited to, a type of free and open-source software web application framework such as Apache Spark™ (hereinafter “Spark”) that can utilize distributed file system 1038 for large-scale data processing (e.g., “big data”). In at least one embodiment, job scheduler 1028 can include a Spark driver to facilitate scheduling of workloads supported by various layers of data center 1000. The configuration manager 1034 can be capable of configuring different layers such as software layer 1030 and framework layer 1020 including Spark and distributed file system 1038 for supporting large-scale data processing. The resource manager 1036 can be capable of managing clustered or grouped computing resources mapped to or allocated for support of distributed file system 1038 and job scheduler 1028. In at least one embodiment, clustered or grouped computing resources can include grouped computing resource 1014 at data center infrastructure layer 1010. The resource manager 1036 can coordinate with resource orchestrator 1012 to manage these mapped or allocated computing resources.

In at least one embodiment, software 1032 included in software layer 1030 can include software used by at least portions of node C.R.s 1016(1)-1016(N), grouped computing resources 1014, and/or distributed file system 1038 of framework layer 1020. One or more types of software can include, but are not limited to, Internet web page search software, e-mail virus scan software, database software, and streaming video content software.

In at least one embodiment, application(s) 1042 included in application layer 1040 can include one or more types of applications used by at least portions of node C.R.s 1016(1)-1016(N), grouped computing resources 1014, and/or distributed file system 1038 of framework layer 1020. One or more types of applications can include, but are not limited to, any number of a genomics application, a cognitive compute, and a machine learning application, including training/updating or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 can implement any number and type of self-modifying actions based at least on any amount and type of data acquired in any technically feasible fashion. Self-modifying actions can relieve a data center operator of data center 1000 from making possibly bad configuration decisions and possibly avoiding underutilized and/or poor performing portions of a data center.

The data center 1000 can include tools, services, software or other resources to train/update one or more machine learning models or predict or infer information using one or more machine learning models according to one or more embodiments described herein. For example, a machine learning model(s) can be trained and/or updated by calculating weight parameters according to a neural network architecture using software and/or computing resources described above with respect to the data center 1000. In at least one embodiment, trained/updated or deployed machine learning models corresponding to one or more neural networks can be used to infer or predict information using resources described above with respect to the data center 1000 by using weight parameters calculated through one or more training/updating techniques, such as but not limited to those described herein.

In at least one embodiment, the data center 1000 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train/update or perform inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 900 of FIG. 9—e.g., each device can include similar components, features, and/or functionality of the computing device(s) 900. In addition, where backend devices (e.g., servers, NAS, etc.) are implemented, the backend devices can be included as part of a data center 1000, an example of which is described in more detail herein with respect to FIG. 10.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server may not be included in a network environment—and one or more client-server network environments—in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and/or functionality of the example computing device(s) 900 described herein with respect to FIG. 9. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
obtain scene data associated with a scene of a three-dimensional environment, the scene comprising a plurality of objects, each object of the plurality of objects being associated with a plurality of primitives;
determine a first set of surfaces and a second set of surfaces corresponding to the plurality of objects, each surface of the first set of surfaces and the second set of surfaces being associated with one or more primitives of the plurality of primitives;
update the one or more primitives associated with the first set of surfaces based at least on a classification of the first set of surfaces; and
generate an image based at least on updating the one or more primitives associated with the first set of surfaces.

2. The processor of claim 1, wherein, to update the one or more primitives associated with the first set of surfaces, the one or more circuits are to:
update the one or more primitives associated with the first set of surfaces by tessellating the one or more primitives associated with the first set of surfaces based at least on a first tessellation factor that is associated with the classification of the first set of surfaces.

3. The processor of claim 2, wherein the one or more circuits are to:
update the one or more primitives associated with the second set of surfaces by tessellating the one or more primitives associated with the second set of surfaces based at least on a second tessellation factor that is associated with the classification of the second set of surfaces,
wherein the first tessellation factor is greater than the second tessellation factor.

4. The processor of claim 2, wherein the one or more circuits are to:
update the one or more primitives associated with the second set of surfaces by tessellating the one or more primitives associated with the second set of surfaces based at least on a second tessellation factor that is associated with the classification of the second set of surfaces,
wherein, where the classification associated with the first set of surfaces indicates the surfaces of the first set of surfaces are forward-facing surfaces, and where the classification associated with the second set of surfaces indicates the surfaces of the second set of surfaces are not forward-facing surfaces, the first tessellation factor is greater than the second tessellation factor.

5. The processor of claim 2, wherein the one or more circuits are to:
update the one or more primitives associated with the second set of surfaces by tessellating the one or more primitives associated with the second set of surfaces based at least on a second tessellation factor that is associated with the classification of the second set of surfaces,
wherein, where the classification associated with the first set of surfaces indicates the surfaces of the first set of surfaces satisfies a first distance threshold, and where the classification associated with the second set of surfaces indicates the surfaces of the second set of surfaces satisfy a second distance threshold, the first tessellation factor is greater than the second tessellation factor, and
wherein the first distance threshold and the second distance threshold are associated with distances from an origin to respective surfaces of the first set of surfaces and the second set of surfaces.

6. The processor of claim 2, wherein the one or more circuits are to:
update the one or more primitives associated with the second set of surfaces by tessellating the one or more primitives associated with the second set of surfaces based at least on a second tessellation factor that is associated with the classification of the second set of surfaces,
wherein, where the classification associated with the first set of surfaces indicates the surfaces of the first set of surfaces are located in a first area of the scene that is directly visible from a view frustum, and where the classification associated with the second set of surfaces indicates the surfaces of the second set of surfaces are located in a second area of the scene that is not directly visible from a view frustum, the first tessellation factor is greater than the second tessellation factor.

7. The processor of claim 2, wherein the one or more circuits are to:
update the one or more primitives associated with the second set of surfaces by tessellating the one or more primitives associated with the second set of surfaces based at least on a second tessellation factor that is associated with the classification of the second set of surfaces,
wherein, where the classification associated with the first set of surfaces indicates the surfaces of the first set of surfaces are closer than corresponding depths stored in a Z-buffer, and where the classification associated with the second set of surfaces indicates the surfaces of the second set of surfaces are farther than corresponding depths stored in the Z-buffer, the first tessellation factor is greater than the second tessellation factor.

8. The processor of claim 1,
wherein, to determine the first set of surfaces and the second set of surfaces corresponding to the respective objects of the plurality of objects, the one or more circuits are to:
determine the one or more primitives corresponding to each surface of the first set of surfaces and the second set of surfaces, and
wherein, to update the one or more primitives associated with the first set of surfaces based at least on the classification associated with the first set of surfaces, the one or more circuits are to:
tessellate the one or more primitives corresponding to each surface of the first set of surfaces based at least on a tessellation factor.

9. The processor of claim 1, wherein, to determine the first set of surfaces and the second set of surfaces, the one or more circuits are to:
determine a classification associated with surfaces associated with the plurality of objects; and
determine the one or more primitives associated with the first set of surfaces and the second set of surfaces based at least on the surfaces associated with the plurality of objects and the classification associated with each surface associated with the plurality of objects.

10. The one or more processors of claim 1, wherein the one or more processors is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing large language models (LLMs);
a system for hosting one or more real-time streaming applications;
a system for performing light transport simulation;
a system for performing collaborative content creation for 3D assets; or
a system implemented at least partially using cloud computing resources.

11. A system comprising:
one or more processors to perform operations comprising:
receiving scene data associated with a scene of a three-dimensional environment, the scene comprising a plurality of objects, each object associated with a plurality of primitives;
determining a first set of surfaces and a second set of surfaces corresponding to the plurality of objects, each surface of the first set of surfaces and the second set of surfaces associated with one or more primitives of the plurality of primitives;
updating the one or more primitives associated with the first set of surfaces based at least on a classification of the first set of surfaces; and
generating an image based at least on updating the one or more primitives associated with the first set of surfaces.

12. The system of claim 11, wherein the one or more processors that perform the operation of updating the one or more primitives associated with the first set of surfaces are to perform the operation of:
updating the one or more primitives associated with the first set of surfaces by tessellating the one or more primitives associated with the first set of surfaces based at least on a first tessellation factor that is associated with the classification of the first set of surfaces.

13. The system of claim 12, wherein the one or more processors are to perform the operation of:
updating the one or more primitives associated with the second set of surfaces by tessellating the one or more primitives associated with the second set of surfaces based at least on a second tessellation factor that is associated with the classification of the second set of surfaces,
wherein the first tessellation factor is greater than the second tessellation factor.

14. The system of claim 12, wherein the one or more processors are to perform the operation of updating the one or more primitives associated with the second set of surfaces by tessellating the one or more primitives associated with the second set of surfaces based at least on a second tessellation factor that is associated with the classification of the second set of surfaces,
wherein, where the classification associated with the first set of surfaces indicates the surfaces of the first set of surfaces are forward-facing surfaces, and where the classification associated with the second set of surfaces indicates the surfaces of the second set of surfaces are not forward-facing surfaces, the first tessellation factor is greater than the second tessellation factor.

15. The system of claim 12, wherein the one or more processors are to perform the operation of updating the one or more primitives associated with the second set of surfaces by tessellating the one or more primitives associated with the second set of surfaces based at least on a second tessellation factor that is associated with the classification of the second set of surfaces,
wherein, where the classification associated with the first set of surfaces indicates the surfaces of the first set of surfaces satisfies a first distance threshold, and where the classification associated with the second set of surfaces indicates the surfaces of the second set of surfaces satisfy a second distance threshold, the first tessellation factor is greater than the second tessellation factor, and
wherein the first distance threshold and the second distance threshold are associated with distances from an origin to respective surfaces of the first set of surfaces and the second set of surfaces.

16. The system of claim 12, wherein the one or more processors are to perform the operation of updating the one or more primitives associated with the second set of surfaces by tessellating the one or more primitives associated with the second set of surfaces based at least on a second tessellation factor that is associated with the classification of the second set of surfaces, and
wherein, where the classification associated with the first set of surfaces indicates the surfaces of the first set of surfaces are located in a first area of the scene that is directly visible from a view frustum, and where the classification associated with the second set of surfaces indicates the surfaces of the second set of surfaces are located in a second area of the scene that is not directly visible from a view frustum, the first tessellation factor is greater than the second tessellation factor.

17. The system of claim 12, wherein the one or more processors are to perform the operation of updating the one or more primitives associated with the second set of surfaces by tessellating the one or more primitives associated with the second set of surfaces based at least on a second tessellation factor that is associated with the classification of the second set of surfaces, and
wherein, where the classification associated with the first set of surfaces indicates the surfaces of the first set of surfaces are closer than corresponding depths stored in a Z-buffer, and where the classification associated with the second set of surfaces indicates the surfaces of the second set of surfaces are farther than corresponding depths stored in the Z-buffer, the first tessellation factor is greater than the second tessellation factor.

18. The system of claim 11, wherein the one or more processors that perform the operation of determining the first set of surfaces and the second set of surfaces corresponding to the respective objects of the plurality of objects are to perform the operation of determining the one or more primitives corresponding to each surface of the first set of surfaces and the second set of surfaces, and
wherein, the one or more processors that perform the operation of updating the one or more primitives associated with the first set of surfaces based at least on the classification associated with the first set of surfaces are to perform the operation of tessellating the one or more primitives corresponding to each surface of the first set of surfaces based at least on a tessellation factor.

19. The system of claim 11, wherein the system is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing large language models (LLMs);
a system for hosting one or more real-time streaming applications;
a system for performing light transport simulation;
a system for performing collaborative content creation for 3D assets; or
a system implemented at least partially using cloud computing resources.

20. A method comprising:
receiving scene data associated with a scene of a three-dimensional environment, the scene comprising a plurality of objects, each object associated with a plurality of primitives;
determining a first set of surfaces and a second set of surfaces corresponding to the plurality of objects, each surface of the first set of surfaces and the second set of surfaces associated with one or more primitives of the plurality of primitives;
updating the one or more primitives associated with the first set of surfaces based at least on a classification of the first set of surfaces; and
generating an image based at least on updating the one or more primitives associated with the first set of surfaces.
